(19) United States
(12) Patent Application Publication
(10) Pub. No.: US 2022/0163867 A1
(43) Pub. Date: May 26, 2022

(54) IMAGING DEVICE, SHUTTER UNIT, AND SHUTTER CONTROL METHOD

(71) Applicant: SONY GROUP CORPORATION, TOKYO (JP)

(72) Inventor: ATSUSHI TANI, TOKYO (JP)

(21) Appl. No.: 17/597,444

(22) PCT Filed: May 24, 2020
(86) PCT No.: PCT/JP2020/020435

§ 371 Date: Jan. 6, 2022

(30) Foreign Application Priority Data
Jul. 17, 2019 (JP) 2019-131787

(51) Int. Cl. G03B 7/00; G03B 9/36; H04N 5/235

(52) U.S. Cl. CPC G03B 7/00; H04N 5/2353; G03B 9/36

(57) ABSTRACT

A weight of a movable portion in a shutter unit is reduced. For this purpose, an imaging device according to the present technology includes: an imaging element that receives light from a subject and performs photoelectric conversion; a control unit that controls a timing of a charge reset of the imaging element; and a shutter unit including a base part that is disposed on a front surface of the imaging element and includes an opening through which light passes, an opening and closing blade that shields a part of the opening from light depending on the timing of the charge reset, and a support part that supports the opening and closing blade. As a result, only one opening and closing blade is included, a width of the opening and closing blade in a traveling direction is smaller than a width of the opening in the traveling direction, and the weight of the movable portion in the shutter unit can be reduced.

### TECHNICAL FIELD

The present technology relates to a technical field of an imaging device, a shutter unit, and a shutter control method. In particular, the present technology relates to an imaging device in which an electronic shutter and a mechanical shutter are combined, a shutter unit, and a shutter control method.

### BACKGROUND ART

There is an imaging device provided with a shutter (for example, a focal plane shutter) for performing appropriate exposure control. As the shutter, there are a front curtain for controlling exposure start and a rear curtain for controlling exposure end.

Among imaging devices, an imaging device is known that uses a mechanical shutter as the front curtain or the rear curtain.

However, the mechanical shutter is heavy, and there is a possibility that a high-speed shutter operation is difficult. In particular, the mechanical shutter often includes a plurality of opening and closing blades, and a mechanism for operating the plurality of opening and closing blades in conjunction with each other is complicated, and fault tolerance is degraded. Furthermore, since the number of opening and closing blades is large, the size of a shutter mechanism (shutter unit) tends to be large, and the moment of inertia at the time of operation tends to be large, so that the impact at the time of curtain travel is large and a failure is likely to occur.

In Patent Document 1, an example is disclosed in which each of the front curtain and the rear curtain that are mechanical shutters includes one opening and closing blade.

### CITATION LIST

### Patent Document

Patent Document 1: WO 2015/146971

### SUMMARY OF THE INVENTION

### Problems to be Solved by the Invention

However, even if each curtain includes one opening and closing blade, the shutter operation is frequently performed, and improvement in fault tolerance and further improvement in reliability are desired.

Thus, an object of the present technology is to improve fault tolerance by reducing a weight of a movable portion in the shutter unit.

### Solutions to Problems

An imaging device according to the present technology includes: an imaging element that receives light from a subject and performs photoelectric conversion; a control unit that controls a timing of a charge reset of the imaging element; and a shutter unit including a base part that is disposed on a front surface of the imaging element and includes an opening through which light passes, an opening and closing blade that shields a part of the opening from light depending on the timing of the charge reset, and a support part that supports the opening and closing blade, in which only one opening and closing blade is included, and a width of the opening and closing blade in a traveling direction is smaller than a width of the opening in the traveling direction.

The shutter unit includes only one opening and closing blade, whereby a weight of the opening and closing blade can be reduced.

The control unit in the above-described imaging device may perform the charge reset prior to traveling of the opening and closing blade.

For example, after the charge reset is performed for each pixel of the imaging element, the opening and closing blade travels after an elapsed time according to the shutter speed.

A moving speed of the opening and closing blade in the above-described imaging device may be determined depending on a reset speed of an electronic front curtain by the charge reset.

For example, the moving speed of the opening and closing blade is equivalent to a charge reset speed of the electronic front curtain.

The control unit in the above-described imaging device may cause charge reading of the imaging element to be started depending on traveling of the opening and closing blade.

For example, the charge reading of each pixel of the imaging element is performed to follow the traveling of the opening and closing blade.

The control unit in the above-described imaging device may cause the charge reading to be started after a traveling start of the opening and closing blade.

For example, the charge reading of each pixel is caused to be started immediately after the traveling start of the opening and closing blade.

The control unit in the above-described imaging device may perform control to cause the charge reading to be performed on a pixel being shielded from light by the opening and closing blade.

As a result, a pixel before being shielded from light by the opening and closing blade is set as a pixel being exposed, and a pixel through which the opening and closing blade has passed is set as a pixel for which the charge reading is completed.

The opening and closing blade in the above-described imaging device may have a first traveling mode in which the opening and closing blade travels from one end side of the opening toward another end side on an opposite side and a second traveling mode in which the opening and closing blade travels from the another end side toward the one end side, and the control unit may have a bidirectional mode in which the charge reset and the charge reading are performed in both the first traveling mode and the second traveling mode.

That is, shutter operation is performed in both a forward path in which the opening and closing blade moves in one direction on the opening and a backward path in which the opening and closing blade moves in an opposite direction.

The control unit in the above-described imaging device may cause the bidirectional mode to be executed in a continuous shooting mode in which still images are continuously acquired.

The continuous shooting mode is, for example, an imaging mode in which still images are continuously acquired in a case where a release button is continuously pressed for a certain period of time or more.

In the above-described imaging device, the support part during traveling of the opening and closing blade may be made not to overlap a non-light-shielded region that is a portion of the opening that is not shielded from light by the opening and closing blade.

The non-light-shielded region that is not shielded from light by the opening and closing blade may be one located on the front end portion side that is an end portion on a traveling direction side of the opening and closing blade, or may be one located on a rear end portion side on an opposite side thereof. The non-light-shielded region is, for example, a region divided only by an edge portion of the opening and the opening and closing blade with a rectangular shape, and has a substantially rectangular shape.

In the above-described imaging device, during the traveling of the opening and closing blade, the support part may be made to overlap the opening and closing blade at an entire portion overlapping the opening.

As a result, the non-light-shielded region is a region divided only by the edge portion of the opening and the opening and closing blade during the traveling of the opening and closing blade.

In the above-described imaging device, during the traveling of the opening and closing blade, an entire portion of the support part may be located outside the opening.

The support part is located outside the opening, whereby the non-light-shielded region during the traveling of the opening and closing blade is a region divided only by the edge portion of the opening and the opening and closing blade.

The shutter unit in the above-described imaging device may include a drive part that drives the support part, and the control unit may change an output of the drive part between the first traveling mode and the second traveling mode.

For example, the first traveling mode is a mode in which the opening and closing blade is moved from the lower side to the upper side of the opening. Furthermore, the second traveling mode is a mode in which the opening and closing blade is moved from the upper side to the lower side of the opening.

The shutter unit in the above-described imaging device may include a drive part that drives the support part, and the control unit may change an output of the drive part depending on a posture of the shutter unit.

There is a possibility that the imaging device is used in various postures depending on imaging situations.

The opening and closing blade in the above-described imaging device may include a front end portion that is an end portion on a traveling direction side and a rear end portion that is an end portion on an opposite side, and the control unit may cause the opening and closing blade to travel at a first speed when a state of the front end portion changes from a state of being located outside the opening to a state of being located in the opening, and cause the opening and closing blade to travel at a second speed lower than the first speed in a state in which the front end portion is located outside the opening and the rear end portion is located in the opening.

For example, in a case where the opening and closing blade travels from a bottom to a top, an upper end portion is the front end portion, and a lower end portion is the rear end portion. Furthermore, in a case where the opening and closing blade travels from the top to the bottom, the lower end portion is the front end portion, and the upper end portion is the rear end portion.

The opening and closing blade travels at the first speed (for example, an initial speed) while the front end portion is located in the opening, and the opening and closing blade travels at the second speed while the front end portion is located outside the opening after reaching an opening end.

A shutter unit of the present technology includes: a base part disposed on a front surface of an imaging element and including an opening through which light is transmitted; an opening and closing blade that shields a part of the opening from light depending on a timing of a charge reset; and the shutter unit including a support part that supports the opening and closing blade, in which only one opening and closing blade is included, and a width of the opening and closing blade in a traveling direction is smaller than a width of the opening in the traveling direction.

A shutter control method of the present technology is a shutter control method in an imaging device including: an imaging element that receives light from a subject, performs photoelectric conversion, and resets electric charge of each of pixels depending on a timing of a charge reset; and a shutter unit including a base part that is disposed on a front surface of the imaging element and includes an opening through which light transmits, an opening and closing blade that shields a part of the opening from light depending on the timing of the charge reset, and a support part that supports the opening and closing blade, in which only one opening and closing blade is included, and a width of the opening and closing blade in a traveling direction is smaller than a width of the opening in the traveling direction, the shutter control method including: performing the charge reset of the imaging element; causing traveling of the opening and closing blade to be started; and performing charge reading of a pixel located in a region shielded from light by the opening and closing blade.

### BRIEF DESCRIPTION OF DRAWINGS

FIG. 1 is a perspective view of an imaging device of an embodiment of the present technology.

FIG. 2 is a rear view of the imaging device.

FIG. 3 is a block diagram of the imaging device.

FIG. 4 is a diagram illustrating arrangement of a shutter unit and an imaging element in a camera housing.

FIG. 5 is a perspective view of the shutter unit.

FIG. 6 is a front view of the shutter unit.

FIG. 7 is a schematic diagram illustrating a state in which an opening and closing blade is at a first standby position.

FIG. 8 is a schematic diagram illustrating the opening and closing blade during traveling.

FIG. 9 is a schematic diagram illustrating a state in which the opening and closing blade is at a second standby position.

FIG. 10 is a conceptual diagram for explaining a state of a pixel region in a state in which the opening and closing blade is at the first standby position.

FIG. 11 is a conceptual diagram for explaining a state in which a charge reset is performed in a part of the pixel region.

FIG. 12 is a conceptual diagram for explaining a state of the pixel region in a state in which the front end portion overlaps the opening.

FIG. 13 is a conceptual diagram for explaining a state in which the charge reset of a part of the pixel region is performed in a state in which the front end portion overlaps the opening.

FIG. 14 is a conceptual diagram for explaining a state of the pixel region in a state in which the front end portion and the rear end portion both overlap the opening.

FIG. 15 is a conceptual diagram for explaining a state of the pixel region in a state in which the front end portion is located outside the opening.

FIG. 16 is a conceptual diagram for explaining a state of the pixel region in a state in which the opening and closing blade is at the second standby position.

FIG. 17 is a flowchart of shutter operation executed by the imaging device.

FIG. 18 is a diagram illustrating an example of performing the shutter operation in a first traveling mode in the imaging device in a normal posture.

FIG. 19 is a diagram illustrating an example of performing the shutter operation in a second traveling mode in the imaging device in the normal posture.

FIG. 20 is a diagram illustrating an example of performing the shutter operation in the first traveling mode in the imaging device in a reverse posture.

FIG. 21 is a diagram illustrating an example of performing the shutter operation in the second traveling mode in the imaging device in the reverse posture.

FIG. 22 is a diagram illustrating an example of performing the shutter operation in the first traveling mode in the imaging device laid down on its side.

FIG. 23 is a diagram illustrating an example of performing the shutter operation in the second traveling mode in the imaging device laid down on its side.

FIG. 24 is a diagram illustrating an example of performing the shutter operation in the first traveling mode in the imaging device laid down on its side in another direction.

FIG. 25 is a diagram illustrating an example of performing the shutter operation in the second traveling mode in the imaging device laid down on its side in the other direction.

FIG. 26 is a schematic diagram for illustrating travel timings of an electronic shutter and a mechanical shutter.

FIG. 27 is a schematic diagram for illustrating travel timings of the electronic shutter and the mechanical shutter in a first modification.

FIG. 28 is a schematic diagram illustrating a base part, an opening and closing blade, and a support part in a second modification.

FIG. 29 is a schematic diagram illustrating the base part, an opening and closing blade, and a support part in a third modification.

FIG. 30 is a schematic diagram for illustrating travel timings of the electronic shutter and the mechanical shutter in a fourth modification.

FIG. 31 is a flowchart of shutter operation in the fourth modification.

### MODE FOR CARRYING OUT THE INVENTION

Hereinafter, embodiments will be described in the following order with reference to the accompanying drawings.

<1. Configuration of imaging device>

<2. Configuration of shutter unit>

<3. Operation of shutter unit>

<4. State of imaging element>

<5. Flowchart of shutter operation>

<6. Correction based on posture information and initial position>

<7. Travel timing of electronic shutter and mechanical shutter>

<8. Modifications>

<9. Conclusion>

<10. Present technology>

### 1. CONFIGURATION OF IMAGING DEVICE

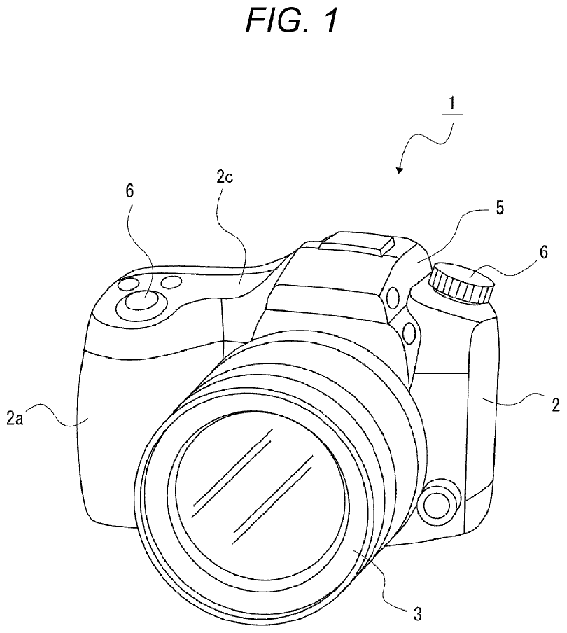

FIG. 1 illustrates an appearance of an imaging device 1 according to the present embodiment.

Note that, in each of the following examples, description will be given with a subject side as the front and a photographer side as the rear, but these directions are for convenience of description, and implementation of the present technology is not limited to these directions.

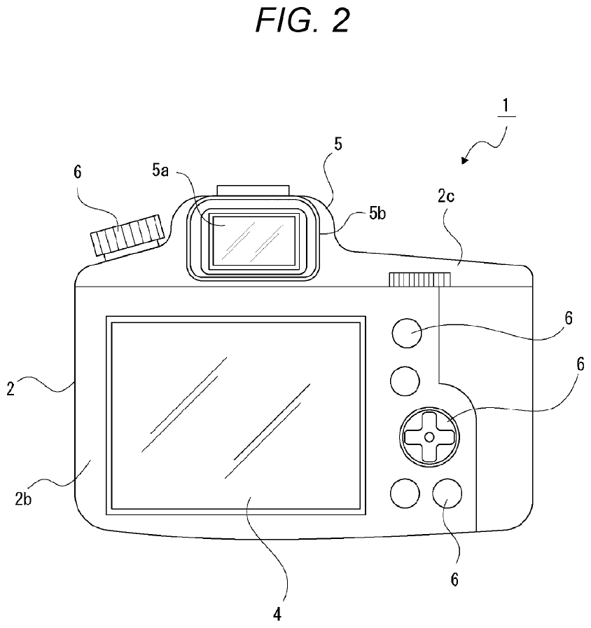

As illustrated in FIGS. 1 and 2, the imaging device 1 includes a camera housing 2 in which necessary units are disposed inside and outside, and a lens housing 3 attached to a front surface portion 2a of the camera housing 2.

A rear monitor 4 is disposed on a rear surface portion 2b of the camera housing 2. A through image, a recorded image, and the like are displayed on the rear monitor 4.

The rear monitor 4 is made to be rotatable with respect to the camera housing 2. For example, a lower end portion of the rear monitor 4 is made to be rotatable to move to the rear with an upper end portion of the rear monitor 4 as a rotation axis.

Note that, a right end portion or a left end portion of the rear monitor 4 may be used as the rotation axis. Moreover, the rear monitor 4 may be made to be rotatable in a plurality of directions.

An electric viewfinder (EVF) 5 is disposed on an upper surface portion 2c of the camera housing 2. The EVF 5 includes an EVF monitor 5a and an enclosing portion 5b with a frame-shape protruding to the rear to surround upper, left, and right sides of the EVF monitor 5a.

Various operation elements 6 are provided on the rear surface portion 2b and the upper surface portion 2c. Examples of the operation elements 6 include a playback menu activation button, an enter button, a cross key, a cancel button, a zoom key, a slide key, a release button (shutter button), and the like.

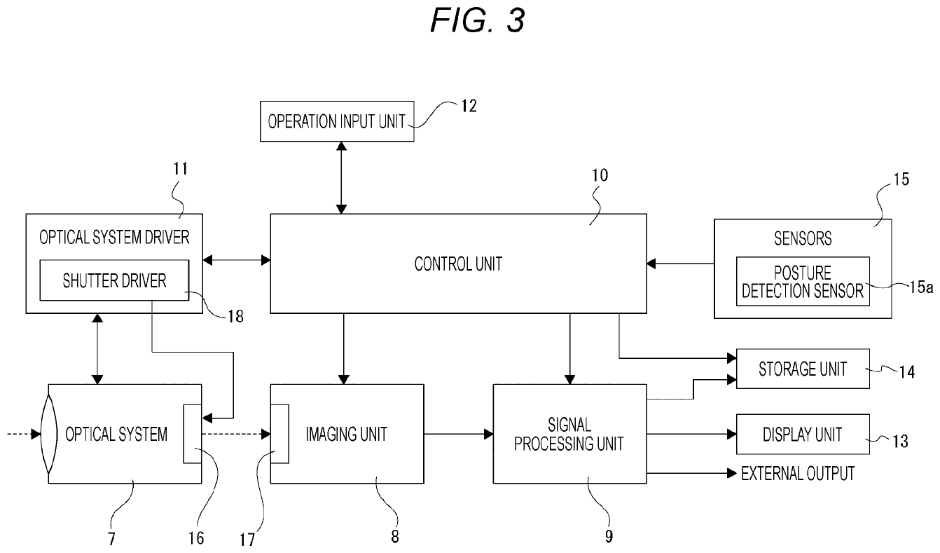

FIG. 3 is a block diagram of the imaging device 1.

The imaging device 1 includes an optical system 7, an imaging unit 8, a signal processing unit 9, a control unit 10, an optical system driver 11, an operation input unit 12, a display unit 13, a storage unit 14, sensors 15, and the like.

Note that, although not illustrated in FIG. 3, the imaging device 1 may further include a memory unit, a communication unit, and the like.

The optical system 7 includes: various lenses such as an incident end lens, a zoom lens, a focus lens, and a condenser lens; an aperture mechanism that performs exposure control by adjusting the lenses, an amount of aperture by an iris (aperture), and the like so that sensing is performed in a state in which signal charge is not saturated and is within a dynamic range; and the like.

Furthermore, the optical system 7 includes a shutter unit 16 that functions as a focal plane shutter. A specific configuration of the shutter unit 16 will be described later.

The imaging unit 8 includes, for example, an imaging element 17 of a charge coupled device (CCD) type or a complementary metal-oxide semiconductor (CMOS) type, and performs exposure control for light from a subject incident through the optical system 7.

A sensor surface of the imaging element 17 includes a sensing element in which a plurality of pixels is two-dimensionally arranged.

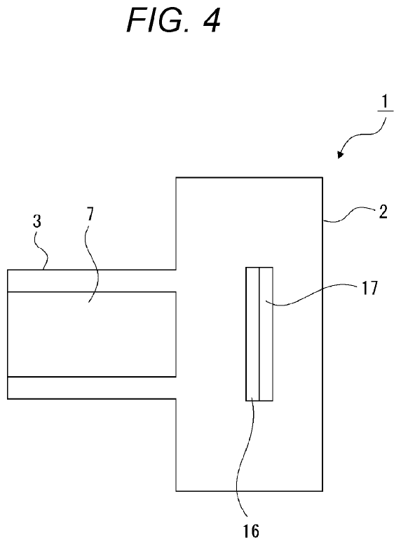

As illustrated in FIG. 4, the imaging element 17 and the shutter unit 16 are both disposed inside the camera housing 2. The shutter unit 16 is disposed immediately before (subject side) the imaging element 17.

The imaging unit 8 performs, for example, correlated double sampling (CDS) processing, automatic gain control (AGC) processing, and the like on an electric signal obtained by photoelectrically converting light received by the imaging element 17, and further performs analog/digital (A/D) conversion processing. Then, captured image data as digital data is output to the signal processing unit 9 in the subsequent stage.

The signal processing unit 9 includes, for example, a microprocessor specialized in digital signal processing such as a digital signal processor (DSP), a microcomputer, or the like.

The signal processing unit 9 includes units for performing various types of signal processing on a digital signal (captured image signal) transmitted from the imaging unit 8.

Specifically, processing is performed such as correction processing between R, G, and B color channels, white balance correction, aberration correction, and shading correction.

Furthermore, the signal processing unit 9 performs each piece of processing such as YC generation processing of generating (separating) a luminance (Y) signal and a color (C) signal from image data of R, G, and B, processing of adjusting luminance and color, knee correction, and gamma correction.

Moreover, the signal processing unit 9 performs conversion into a final output format by performing resolution conversion processing, codec processing that performs encoding for recording or communication, and the like. The image data converted into the final output format is stored in the storage unit 14. Furthermore, the image data is output to the display unit 13, whereby an image is displayed on the rear monitor 4 or the EVF monitor 5a. Moreover, by being output from an external output terminal, the image is displayed on a device such as a monitor provided outside the imaging device 1.

The control unit 10 performs overall control of the imaging device 1. For example, control of a shutter speed according to operation of a photographer, switching of various imaging modes, and the like are performed. Examples of the various imaging modes include a still image imaging mode, a moving image imaging mode, and a continuous shooting mode for continuously acquiring still images.

Furthermore, the control unit 10 instructs the optical system driver 11 to control the various lenses included in the optical system 7.

The optical system driver 11 is provided with, for example, a shutter driver 18 including an electronic circuit and the like for controlling the shutter unit 16, together with a motor driver for a zoom lens drive motor, a motor driver for a focus lens drive motor, a motor driver for a motor for driving the aperture mechanism, and the like.

The control unit 10 is made to be able to acquire information on various lenses included in the optical system 7. The information on the lens includes, for example, information on a model number of the lens, a position of the zoom lens, an F-number (aperture value), or information on an exit pupil position.

The operation input unit 12 includes the various operation elements 6 provided in the camera housing 2 and the like, and outputs operation information according to operation of the photographer to the control unit 10.

The display unit 13 is, for example, the rear monitor 4 or the EVF monitor 5a. The display unit 13 performs processing of displaying the image data input from the signal processing unit 9 and converted to have an appropriate resolution.

Note that, the display unit 13 may be caused to function as a part of the operation input unit 12 by being provided with a touch panel that detects touch operation on its display surface.

The storage unit 14 includes, for example, a non-volatile memory, and functions as a storage means that stores an image file (content file) such as still image data or moving image data, attribute information of the image file, a thumbnail image, and the like.

The image file is stored in a format, for example, joint photographic experts group (JPEG), tagged image file format (TIFF), graphics interchange format (GIF), or the like.

Various actual forms of the storage unit 14 are conceivable. For example, the storage unit 14 may be configured as a flash memory incorporated in the imaging device 1, or may include a memory card (for example, a portable flash memory) that can be attached to and detached from the imaging device 1 and an access unit that accesses the memory card for storage and reading. Furthermore, as a form incorporated in the imaging device 1, the storage unit 14 may be implemented as a hard disk drive (HDD) or the like.

The sensors 15 comprehensively indicate various sensors included in the imaging device 1. FIG. 3 illustrates a posture detection sensor 15a as an example of the sensors included in the imaging device 1.

The posture detection sensor 15a includes, for example, an acceleration sensor and an angular velocity sensor, detects a position change and a posture change of the camera housing 2, and transmits detection signals respectively as acceleration data and angular velocity data to the control unit 10.

The control unit 10 can grasp a posture and a posture change of the camera housing 2 on the basis of those detection signals. The posture detection sensor 15a may be used not only for correction processing to be described later but also for camera shake correction.

The acceleration sensor is provided for each of the X axis, the Y axis, and the Z axis orthogonal to each other, for example. Furthermore, the angular velocity sensor detects, for example, rotation of each of pitch, yaw, and roll.

Furthermore, a proximity sensor may be provided as the sensors 15. The proximity sensor is provided, for example, near the EVF monitor 5a, detects that a user's face approaches the EVF monitor 5a, and transmits a detection signal to the control unit 10. The control unit 10 performs ON/OFF operation or the like of various display devices on the basis of the detection signal.

### 2. CONFIGURATION OF SHUTTER UNIT

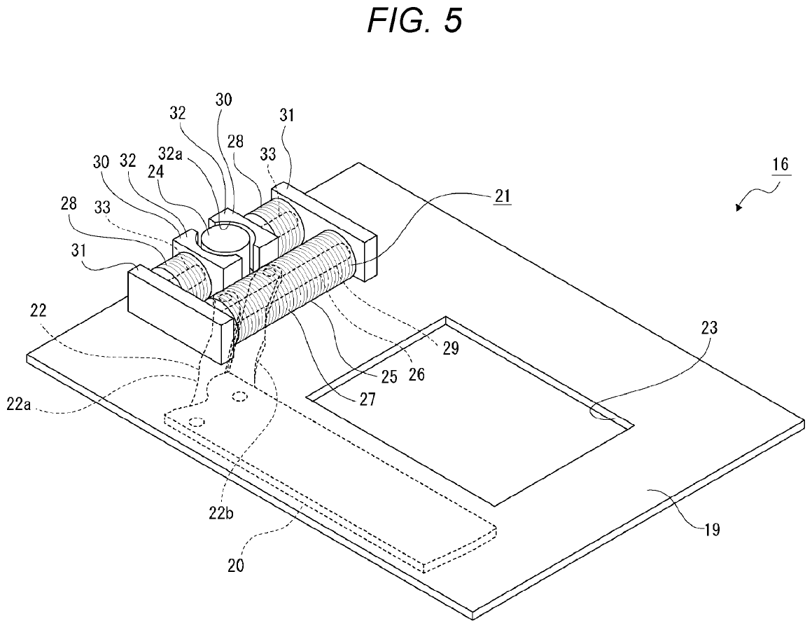

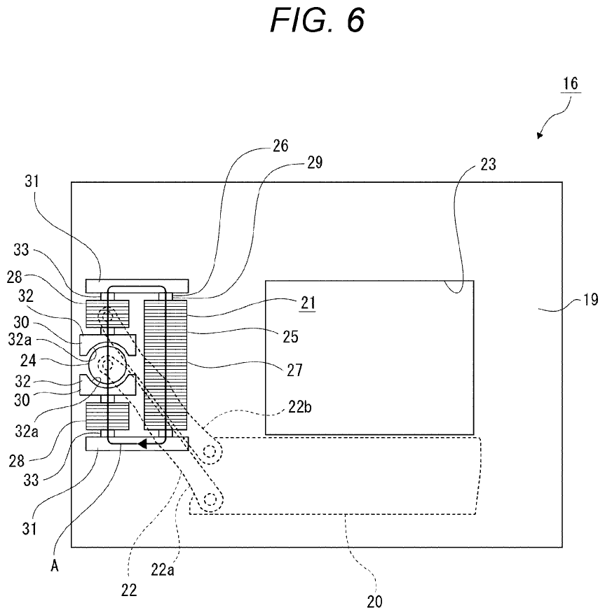

A specific configuration of the shutter unit 16 will be described with reference to FIGS. 5 and 6.

The shutter unit 16 includes a base part 19, an opening and closing blade 20, a drive part 21, and a support part 22.

The base part 19 is formed in a rectangular plate shape facing the front-rear direction, and is provided with an opening 23 penetrating therethrough in the front-rear direction. Note that, in the following description, unless otherwise noted, the short side direction of the base part 19 is defined as the vertical direction, the longitudinal direction is defined as the left-right direction, and the thickness direction is defined as the front-rear direction.

The opening 23 is a rectangular opening, and allows light incident through various lenses disposed in front to pass to the rear.

The opening and closing blade 20 is disposed on a rear surface portion (imaging element 17 side) of the base part 19, and is a single sheet-like light shielding member. The opening and closing blade 20 has a substantially rectangular shape, and has a length in the left-right direction longer than a length in the longitudinal direction of the opening 23 and a length in the vertical direction shorter than a length in the short side direction of the opening 23. That is, one opening and closing blade 20 cannot cover the entire opening 23.

The drive part 21 generates driving force for driving the opening and closing blade 20 in the substantially vertical direction via the support part 22.

The drive part 21 includes a magnet 24, a coil unit 25, and a yoke unit 26.

Note that, FIG. 6 illustrates the shutter unit 16 as viewed from the subject side. As illustrated in the figure, in the shutter unit 16 viewed from the subject side, the drive part 21 is provided on the left side of the opening 23.

The magnet 24 is formed in a cylindrical shape whose axial direction is the front-rear direction, and for example, the magnetization direction of the S pole and the N pole is the radial direction. The magnet 24 is attached in a state of being rotatable by at least a predetermined angle.

The coil unit 25 includes one long axis coil 27 and two short axis coils 28 and 28. The long axis coil 27 is disposed on an end portion side of the base part 19, the short axis coils 28 and 28 are disposed in a state of being vertically separated from each other between the long axis coil 27 and the opening 23, and the axial direction of each coil is the vertical direction.

The yoke unit 26 includes a shaft-shaped yoke part 29, counter yoke parts 30 and 30, and flat plate yoke parts 31 and 31.

The shaft-shaped yoke part 29 is formed so that its axial direction is the vertical direction and has substantially the same length as the long axis coil 27.

Each counter yoke part 30 includes a counter part 32 formed in a block shape and a shaft-shaped part 33 protruding laterally from the counter part 32, and a surface of the counter part 32 on an opposite side form the shaft-shaped part 33 is formed as a recessed surface portion 32a with an arc-shape. The counter yoke parts 30 and 30 are disposed such that the recessed surface portions 32a and 32a of the counter parts 32 and 32 face each other. The magnet 24 is disposed in a substantially cylindrical space formed between the recessed surface portions 32a and 32a.

Each flat plate yoke part 31 is formed in a flat plate shape facing the vertical direction. Both end portions of the shaft-shaped yoke part 29, and front end portions of the shaft-shaped parts 33 and 33 of the counter yoke parts 30 and 30 are coupled to the pair of flat plate yoke parts 31 and 31.

The shaft-shaped yoke part 29 is inserted into the long axis coil 27, and the long axis coil 27 is held by the shaft-shaped yoke part 29. The shaft-shaped parts 33 and 33 of the counter yoke parts 30 and 30 are respectively inserted into the short axis coils 28 and 28, and each short axis coil 28 is held by the corresponding counter yoke part 30.

The coil unit 25 and the yoke unit 26 are assembled together, whereby a magnetic circuit A is formed in the drive part 21 (see FIG. 6). Note that, by switching the direction of a current caused to flow through the coil unit 25, any one of the magnetic circuit A and a magnetic circuit B (not illustrated) in an opposite direction to the magnetic circuit A can be caused to appear in the drive part 21.

The support part 22 includes two links 22a and 22b that are driven in a state of being parallel to each other. One of the two links, the link 22a, has one end portion coupled to the magnet 24, and the other end portion coupled to the opening and closing blade 20. The other link, the link 22b, has one end portion coupled to the base part 19 (not illustrated), and the other end portion coupled to the opening and closing blade 20.

### 3. OPERATION OF SHUTTER UNIT

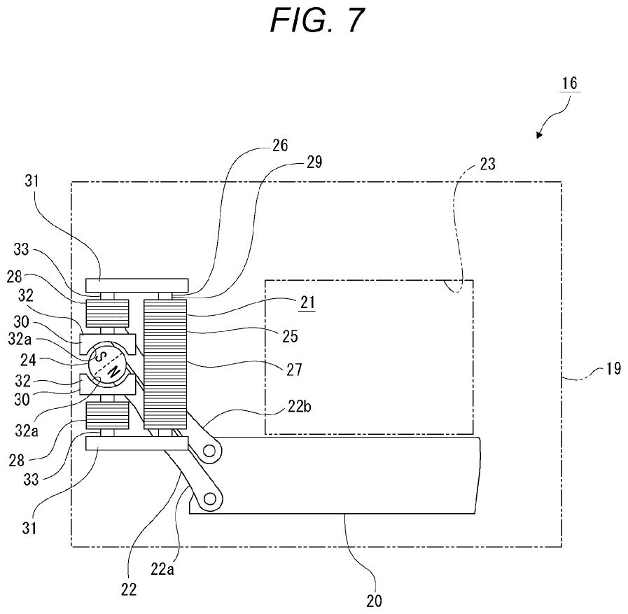

Operation of the shutter unit 16 will be described with reference to FIGS. 7 to 9. Note that, in each drawing, the base part 19 is indicated by a two-dot chain line.

The shutter unit 16 performs curtain travel as a part of shutter operation by vertically moving the opening and closing blade 20 to sequentially cover the opening 23 from one end side to the other end side.

Specifically, depending on rotation of the magnet 24, the support part 22 is rotated with one end portion coupled to the magnet 24 as a fulcrum. Depending on the rotation of the support part 22, the opening and closing blade 20 moves on the opening 23 while the longitudinal direction is kept to be the left-right direction.

In FIG. 7, the magnetization direction of the magnet 24 is slightly inclined with respect to the left-right direction. The S pole of the magnet 24 is located above, and the N pole is located below.

The support part 22 is made to be located lower at a place farther from the magnet 24.

The opening and closing blade 20 is located below the opening 23.

A position of the opening and closing blade 20 illustrated in FIG. 7 is a “first standby position”. The first standby position is one of positions of the opening and closing blade 20 in a standby state before traveling.

A current in a predetermined direction is caused to flow through the coil unit 25 in the state illustrated in FIG. 7, whereby the magnet 24 rotates. As the magnet 24 rotates, the support part 22 rotates, and the opening and closing blade 20 moves substantially upward while drawing an arc.

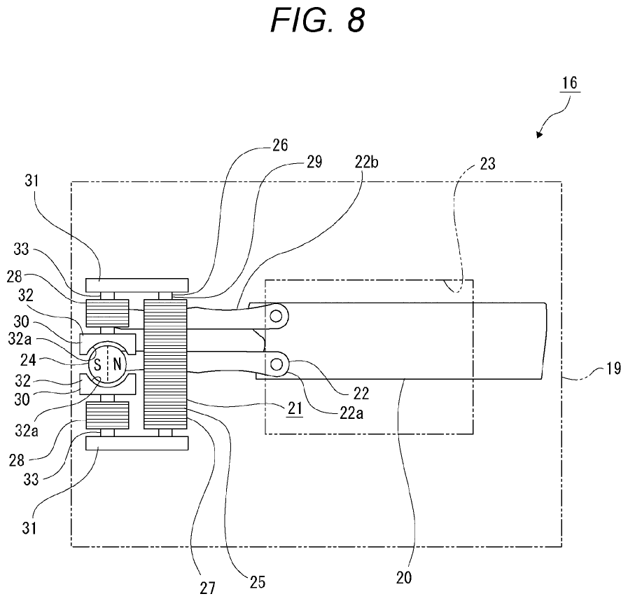

FIG. 8 illustrates a state in which the opening and closing blade 20 is on the way to move upward from the state illustrated in FIG. 7.

In FIG. 8, the magnetization direction of the magnet 24 is the left-right direction, and the direction in which the support part 22 extends is also the left-right direction. In this state, the opening 23 is vertically divided by the opening and closing blade 20. Note that, in the following description, in the opening and closing blade 20, an end portion on the traveling side is referred to as a front end portion 20a, and an end portion on the opposite side is referred to as a rear end portion 20b.

As compared with FIG. 7, the state illustrated in FIG. 8 is a state in which the opening and closing blade 20 has moved slightly rightward, and even in that state, the width of the opening and closing blade 20 in the left-right direction covers the width of the opening 23 in the left-right direction. That is, the width of the opening and closing blade 20 in the left-right direction is made larger than the width of the opening 23 in the left-right direction, the left end of the opening and closing blade 20 is located on the left side of the left end of the opening 23, and the right end of the opening and closing blade 20 is located on the right side of the right end of the opening 23.

Note that, in the support part 22, a portion covering the opening 23 is disposed to overlap also the opening and closing blade 20. That is, in the opening 23, there is no region shielded only by the support part 22. In other words, the support part 22 is located not to overlap a non-light-shielded region that is not shielded from light by the opening and closing blade 20. This is similar not only in the state illustrated in FIG. 8 but also in any rotation state of the support part 22, that is, during traveling of the opening and closing blade 20.

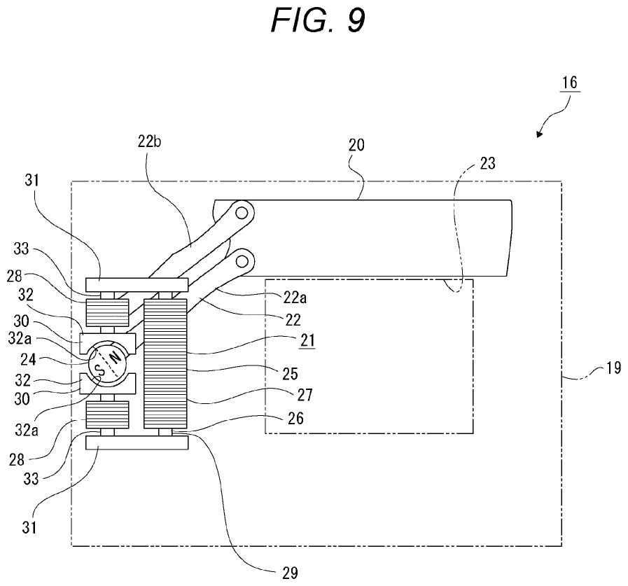

The state illustrated in FIG. 9 is a state continuing from FIGS. 7 and 8, and is a state in which traveling of the opening and closing blade is completed. Note that, in the present embodiment, there are provided a mode (first traveling mode) in which the opening and closing blade 20 plays a part of the shutter operation while traveling from the lower side (first standby position) to the upper side, and a mode (second traveling mode) in which the opening and closing blade 20 plays a part of the shutter operation while traveling from the upper side to the lower side. In the second traveling mode, the opening and closing blade 20 changes from the state illustrated in FIG. 9 to the state illustrated in FIG. 7 via the state illustrated in FIG. 8.

The imaging device 1 may include only one of the traveling modes. For example, the opening and closing blade 20 may be configured to always move from the first standby position when the shutter operation is executed. In this case, the opening and closing blade 20 is moved to the first standby position after the shutter operation is ended, thereby preparing for execution of the next shutter operation.

Furthermore, the imaging device 1 may include a bidirectional mode in which both traveling modes are executable. For example, only one of the traveling modes may be executed in normal imaging, and a bidirectional mode in which both traveling modes are alternately executed may be used in imaging in the continuous shooting mode.

Thus, the state illustrated in FIG. 9 is a state in which the traveling of the opening and closing blade is completed, and is also a standby state in the second traveling mode. A position of the opening and closing blade 20 illustrated in FIG. 9, that is, a position above the opening 23 is a “second standby position”.

Note that, since the end portion on the traveling side of the opening and closing blade 20 is the front end portion 20a, the front end portion 20a and the rear end portion 20b are switched between the first traveling mode and the second traveling mode. That is, in the first traveling mode, the upper end portion of the opening and closing blade 20 is the front end portion 20a, and the lower end portion is the rear end portion 20b. In the second traveling mode, the lower end portion of the opening and closing blade 20 is the front end portion 20a, and the upper end portion is the rear end portion 20b.

Note that, the first standby position is a position below the opening 23 in the imaging device 1 that takes a normal posture, and is a position above the opening 23 in the imaging device 1 that takes an upside down posture such that the EVF 5 is located below. That is, depending on the posture of the imaging device 1, the first standby position may be located above the second standby position.

In the following description, a normal posture in which the EVF 5 of the imaging device 1 is located on the upper part is referred to as a “normal posture”. Furthermore, the upside-down posture in which the EVF 5 is located at the lower part is referred to as a “reverse posture”.

### 4. STATE OF IMAGING ELEMENT

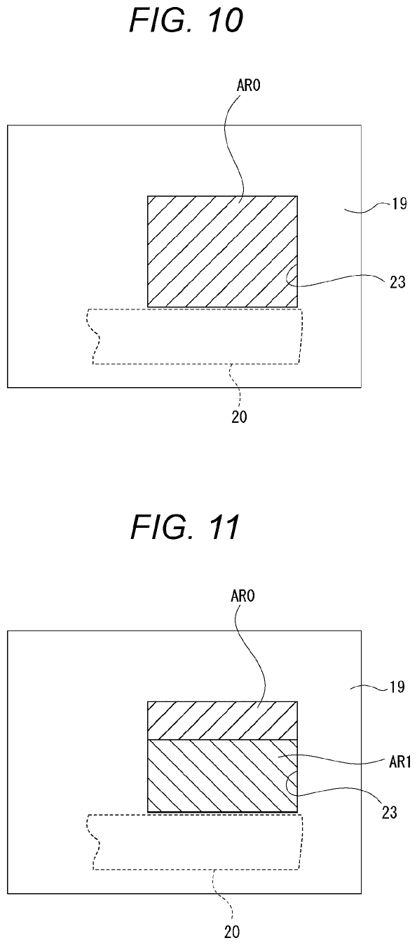

A change in a state of the imaging element 17 accompanying the operation of the opening and closing blade 20 described with reference to each of FIGS. 7 to 9 will be described with reference to each of FIGS. 10 to 15.

Each figure illustrates the base part 19 of the shutter unit 16, the opening 23 formed in the base part 19, and the opening and closing blade 20. Furthermore, various types of hatching are applied to regions of the opening 23. Each piece of the hatching is for explaining a state of each pixel of the imaging element 17.

For example, the state illustrated in FIG. 10 is a state in which the opening and closing blade 20 is located at the first standby position, and indicates a state before the shutter operation is performed (state before pressing of the release button) or a state immediately after a start of the shutter operation.

As illustrated in the figure, each pixel of the imaging element 17 is in a state in which the charge is not reset, that is, in a state before a charge reset. A pixel region in the state before the charge reset is illustrated as a region AR0 in each figure.

When the release button is pressed, the state transitions from the state illustrated in FIG. 10 to the state illustrated in FIG. 11. In the imaging element 17, the charge reset is executed in order from a pixel located at the lowermost row with the pressing of the release button. In the state illustrated in FIG. 11, a pixel located in the upper part of the imaging element 17 is set as an unreset state (region AR0), and a pixel located in the lower part is set as a reset state (region AR1).

After a predetermined time has elapsed from the state illustrated in FIG. 11, the entire region of the imaging element 17 is set as the reset state (region AR1). Thereafter, when an exposure time of the pixel located at the lowermost row of the imaging element 17 reaches a predetermined time, the opening and closing blade 20 starts traveling upward from the first standby position.

Note that, in a case where it takes time for the opening and closing blade 20 to move from the first standby position and shield a part of the opening from light, it is necessary to cause the traveling of the opening and closing blade 20 to be started before the exposure time of the pixel located at the lowermost row reaches the predetermined time.

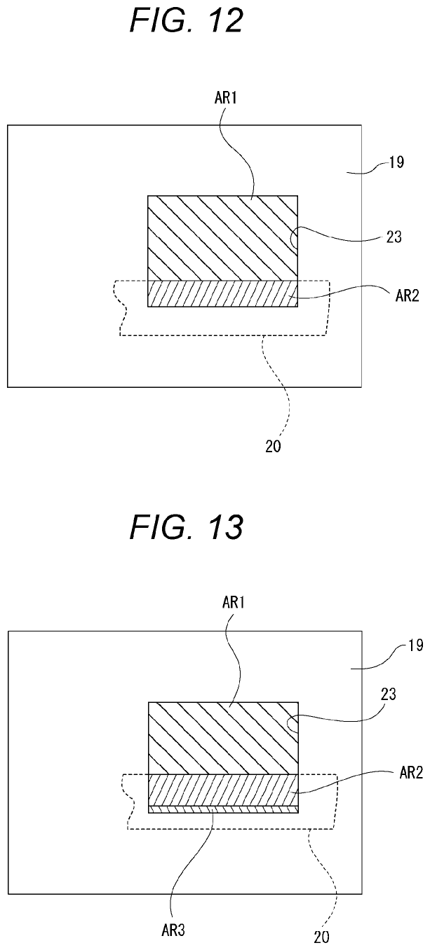

The state illustrated in FIG. 12 is a state in which a part of the region in the opening and closing blade 20 after a traveling start covers the lower side of the opening 23.

A pixel region being exposed through the opening 23 is set as the region AR1 that is in the reset state, and a pixel region shielded from light by the opening and closing blade 20 is set as a region AR2 that is in a reset state and in a state in which the exposure is ended.

When the traveling of the opening and closing blade 20 further progresses from the state illustrated in FIG. 12, the lower end of the opening and closing blade 20 overlaps the opening 23, and the pixel located at the lowermost row is exposed again. To avoid that, in the present embodiment, charge reading for each pixel of the imaging element 17 is started before the lower end of the opening and closing blade 20 reaches the lower end of the opening 23.

The pixel region in which the charge reading has been executed is set as a region AR3 (see FIG. 13).

In the state illustrated in FIG. 13, in the pixel region shielded from light by the opening and closing blade 20, a part thereof is set as the region AR2, and a remaining part is set as the region AR3.

That is, it can be said that the pixel located in the region AR2 is a pixel in the reset state and in a state in which the exposure is ended, and further in a state in which the charge reading is not completed.

Furthermore, a pixel located in the region AR3 can be said to be a pixel in a state in which the exposure is ended by light shielding by the opening and closing blade 20 and in a state in which the charge reading is completed.

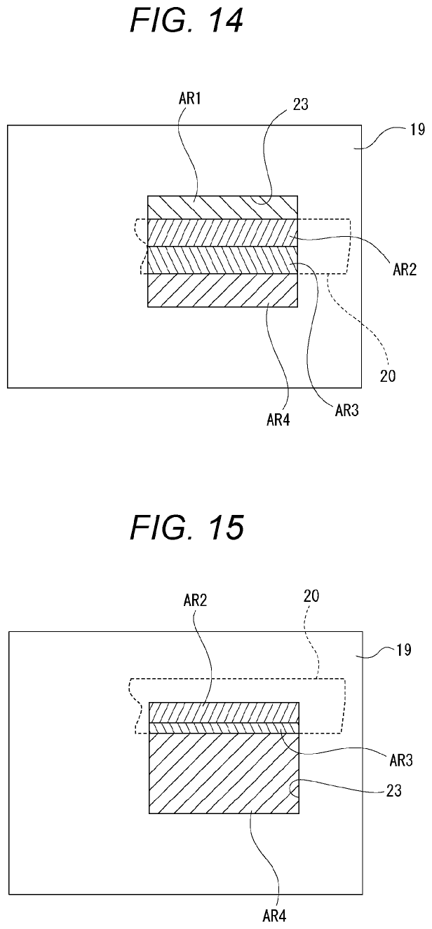

When the traveling of the opening and closing blade 20 further progresses, both the front end portion 20a and the rear end portion 20b are in a state of being located within the opening 23 (see FIG. 14).

In this state, a pixel region located above the front end portion 20a is set as the region AR1, and a part of the pixel region shielded from light by the opening and closing blade 20 is set as the region AR2 and the rest is set as the region AR3. Moreover, a pixel region located below the rear end portion 20b is set as a region AR4.

The region AR4 is a pixel region in a state in which the charge reading is completed and is a region through which the opening and closing blade 20 has passed.

When the traveling of the opening and closing blade 20 further progresses, the front end portion 20a is in a state of being located above the opening 23 (see FIG. 15).

In this state, a part of the pixel region shielded from light by the opening and closing blade 20 is set as the region AR2 and the rest is set as the region AR3, and a pixel region located below the rear end portion 20b is set as the region AR4.

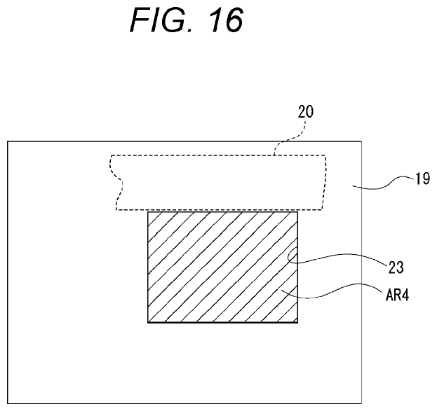

The state illustrated in FIG. 16 is a state in which the first traveling mode of the opening and closing blade 20 is completed. The entire region of the imaging element 17 is set as the region AR4.

Note that, as the second traveling mode, in the state illustrated in FIG. 16, the entire region of the imaging element 17 is in a state before the charge reset.

That is, in the state illustrated in FIG. 16, the entire region is set as the region AR4 in the case of being regarded as the first traveling mode, and the entire region is set as the region AR0 in the case of being regarded as the second traveling mode.

### 5. FLOWCHART OF SHUTTER OPERATION

The imaging device 1 in the present embodiment implements the shutter operation by combining physical curtain travel using the opening and closing blade 20, charge reset processing, and charge reading processing.

The charge reset processing can be regarded as an electronic front curtain. Furthermore, the charge reading processing can be regarded as an electronic rear curtain.

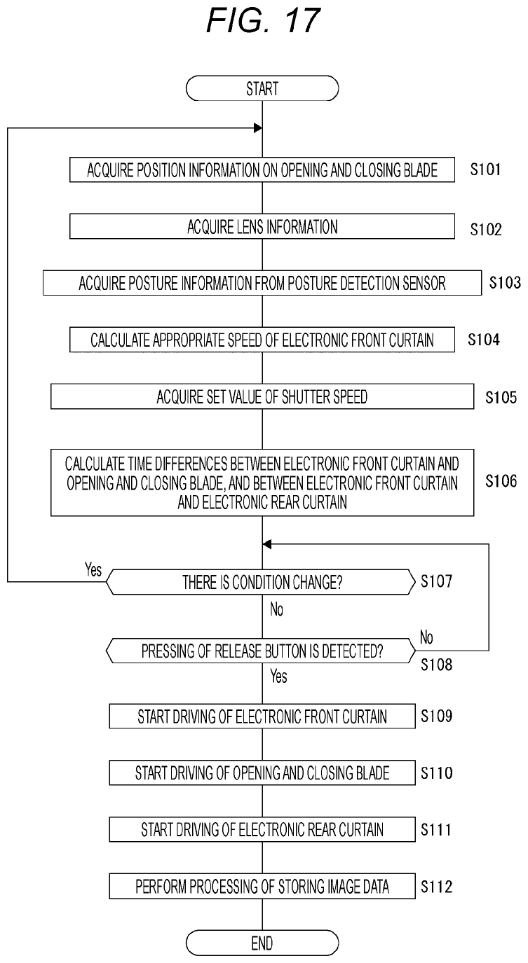

A flow of the shutter operation of the imaging device 1 in the present embodiment will be described with reference to FIG. 17.

Note that, the following pieces of processing are pieces of processing executed by units (for example, the control unit 10 and the like) of the imaging device 1 of the present embodiment.

In step S101, the imaging device 1 acquires position information (initial position) on the opening and closing blade 20. Specifically, information is acquired that can specify whether the opening and closing blade 20 is located at the first standby position below the opening 23 of the base part 19, or the opening and closing blade 20 is located at the second standby position above the opening 23 of the base part 19.

In step S102, the imaging device 1 acquires various types of lens information of the optical system 7. The acquired lens information is used to calculate the exit pupil position.

When the exit pupil position varies, the pixel region varies on the imaging element 17 that is shielded from light depending on the position of the opening and closing blade 20. By determining a moving speed (hereinafter, described as “curtain speed”) of the opening and closing blade 20 depending on this difference, a desired exposure time can be achieved regardless of a difference in the exit pupil position.

In step S103, the imaging device 1 acquires posture information on the imaging device 1 from the posture detection sensor 15a.

In step S104, the imaging device 1 calculates an appropriate speed of the electronic front curtain, that is, an appropriate execution speed of the charge reset. Specifically, the appropriate speed of the electronic front curtain is calculated on the basis of the position information, exit pupil position information, and posture information of the opening and closing blade 20 acquired in pieces of processing of respective steps S101, S102, and S103.

In step S105, the imaging device 1 acquires a set value of the shutter speed. The shutter speed is determined by, for example, manual setting by a photographer or automatic setting associated with exposure control.

In step S106, the imaging device 1 calculates a time difference dT1 between a start timing of the electronic front curtain and a traveling start timing of the opening and closing blade 20 (time length dT1 from a start of the electronic front curtain to the traveling start of the opening and closing blade 20), and a time difference dT2 between the start timing of the electronic front curtain and a start timing of the electronic rear curtain (start timing of the charge reading processing).

Note that, instead of calculating the time difference dT2, a time difference between the traveling start timing of the opening and closing blade 20 and the start timing of the electronic rear curtain may be calculated.

These time differences dT1 and dT2 are calculated depending on the appropriate speed of the electronic front curtain calculated in step S104 and the shutter speed calculated in step S105.

In step S107, the imaging device 1 determines whether there is a condition change. For example, it is determined whether or not there is a discrepancy between information regarding the posture of the imaging device 1 acquired in step S103 and the posture of the imaging device 1 at the time of execution of step S107. That is, in step S106 described above, since the calculation based on the posture information acquired in step S103 is performed, there is a possibility that appropriate exposure control cannot be performed in a case where the posture of the imaging device 1 has changed.

For that reason, in a case where the posture information has changed, that is, in a case where it is determined that there is a condition change (step S107: Yes determination), the imaging device 1 returns to the processing of step S101 again.

Note that, in a case where the posture of the imaging device 1 has changed, it may be configured so that only the processing of step S103 is executed again among steps S101, S102, and S103, and then pieces of processing of steps S104, S105, and S106 are executed.

Note that, conditions to be processing targets in step S107 include not only the posture information on the imaging device 1 but also lens information and the like. For example, in a case where there is a change in the position of the zoom lens, it is necessary to acquire the lens information again, and thus, it is determined that there is a condition change in the processing of step S107.

As understood from the above, in a case where there is a change in the condition so that the time differences dT1 and dT2 calculated in step S106 are not appropriate any longer, it is desirable to determine that there is a condition change in the determination processing in step S107 without sticking to each example described above.

After it is determined in step S107 that there is no condition change, the imaging device 1 determines in step S108 whether or not pressing of the release button is detected. In a case where the pressing of the release button is not detected, the imaging device 1 returns to the processing of step S107.

By executing each piece of processing from step S101 to step S108, the imaging device 1 calculates the time difference dT1 between the start timings of the electronic front curtain and the opening and closing blade 20, and the time difference dT2 between the start timings of the electronic front curtain and the electronic rear curtain, and then confirms whether there is a condition change and determines whether or not the pressing of the release button is detected. Then, while each of the time differences is calculated again every time the condition change is detected, waiting is performed until the pressing of the release button is detected.

In a case where the pressing of the release button is detected in step S108, the imaging device 1 causes driving of the electronic front curtain to be started in step S109, causes driving of the opening and closing blade 20 to be started on the basis of the time difference dT1 in step S110, and causes driving of the electronic rear curtain to be started on the basis of the time difference dT2 in step S111.

As a result, it is possible to perform exposure control so that each pixel of the imaging element 17 is exposed for a specific time. In particular, by determining the time difference dT2 so that the charge reading is executed while the pixel is shielded from light by the opening and closing blade 20, the exposure time can be kept constant.

Note that, when the driving of the electronic front curtain and the electronic rear curtain is caused to be started, the position information of the opening and closing blade 20 acquired in the processing of step S101 is used.

Specifically, in a case where a position (initial position) of the opening and closing blade 20 at the time of pressing the release button is the first standby position, the charge reset as the electronic front curtain is executed from a pixel close to the first standby position. Similarly, the electronic rear curtain is executed from the pixel close to the first standby position. That is, in the normal posture of the imaging device 1, the charge reset and the charge reading are performed from a pixel located below.

On the other hand, in a case where the initial position of the opening and closing blade 20 is the second standby position, a processing start pixel of the electronic front curtain or the electronic rear curtain is a pixel close to the second standby position. That is, in the normal posture of the imaging device 1, the charge reset and the charge reading are performed from a pixel located above.

Note that, the order of the pieces of processing of steps S109, S110, and S111 may change depending on the conditions. For example, in consideration of the time required for the front end portion 20a of the opening and closing blade 20 to reach the lower end portion of the opening 23 from the first standby position, the driving of the opening and closing blade 20 may be performed prior to the driving of the electronic front curtain. With such control, the first standby position can be set further below.

After executing the pieces of processing of steps S109, S110, and S111, the imaging device 1 performs processing of storing image data in step S112. By this processing, for example, the image data is temporarily stored in a memory included in the control unit 10.

Note that, in step S112, processing may be performed so that the image data is stored in the storage unit 14 such as a flash memory.

### 6. CORRECTION BASED ON POSTURE INFORMATION AND INITIAL POSITION

As described above with reference to FIG. 17, to calculate the appropriate speed of the electronic front curtain in step S104, the initial position information of the opening and closing blade 20 is acquired in step S101, and the posture information of the imaging device 1 is acquired in step S103.

Here, a description will be given of correction performed on the basis of the initial position information of the opening and closing blade 20 and the posture information of the imaging device 1.

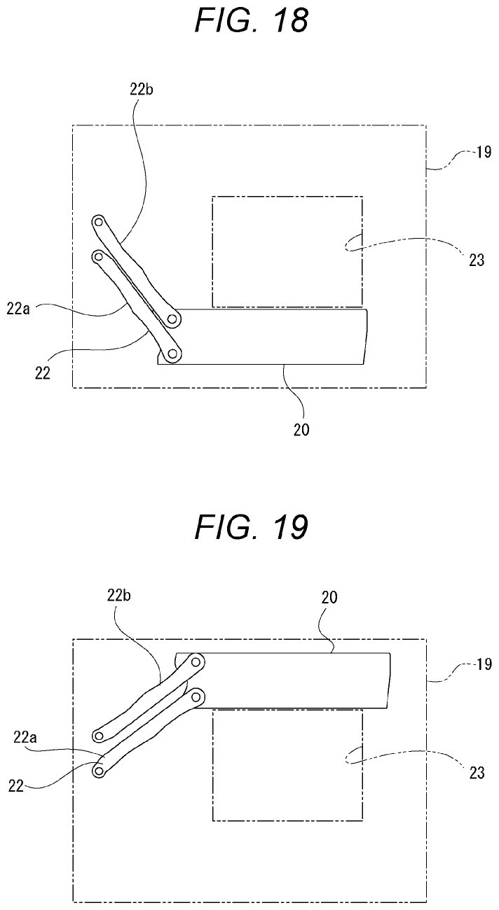

First, correction in a case where the imaging device 1 is in the normal posture will be described with reference to FIGS. 18 and 19.

FIG. 18 illustrates a case where the initial position of the opening and closing blade 20 is the first standby position. In a case where the opening and closing blade 20 starts traveling in the first traveling mode from this state, it is conceivable that the curtain speed of the opening and closing blade 20 reduces due to gravity. To correct this, it is conceivable to reduce the execution speed of the electronic front curtain in accordance with the curtain speed of the opening and closing blade 20. As a result, the curtain speed of the opening and closing blade 20 and the speed of the electronic front curtain are substantially the same speed, and the exposure time of each pixel can be kept uniform.

Note that, instead of reducing the speed of the electronic front curtain, an output of the drive part 21 may be increased by increasing a current caused to flow to the drive part 21, and the curtain speed of the opening and closing blade 20 may be increased. Even with such a configuration, the exposure time of each pixel can be made uniform.

FIG. 19 illustrates a case where the initial position of the opening and closing blade 20 is the second standby position. In a case where the opening and closing blade 20 starts traveling in the second traveling mode from this state, the opening and closing blade 20 moves in the gravity direction, so that it is conceivable that the curtain speed of the opening and closing blade 20 increases.

To correct this, it is conceivable to increase the execution speed of the electronic front curtain in accordance with the curtain speed of the opening and closing blade 20. As a result, the curtain speed of the opening and closing blade 20 and the speed of the electronic front curtain are substantially the same speed, and the exposure time of each pixel can be made uniform.

Note that, instead of increasing the speed of the electronic front curtain, the output of the drive part 21 may be reduced by reducing the current caused to flow to the drive part 21, and the curtain speed of the opening and closing blade 20 may be reduced. Even with such a configuration, the exposure time of each pixel can be made uniform.

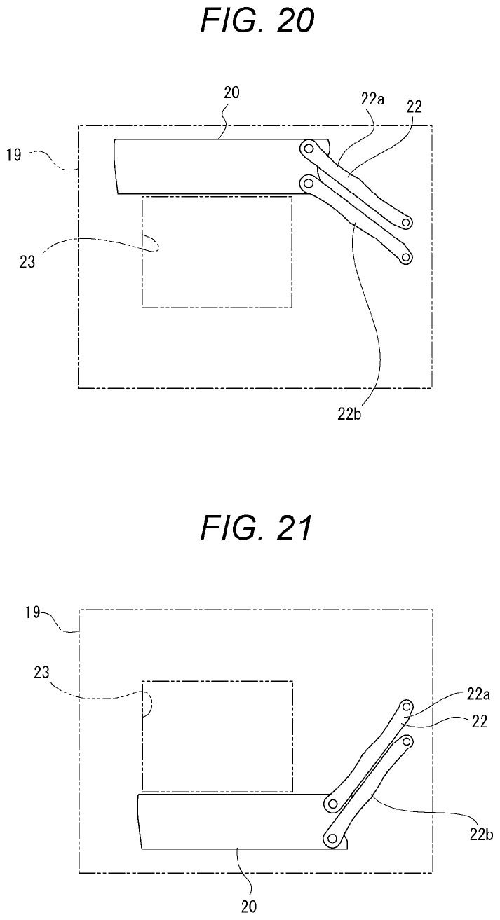

Next, correction in a case where the imaging device 1 is in the reverse posture will be described with reference to FIGS. 20 and 21.

FIG. 20 illustrates a case where the initial position of the opening and closing blade 20 is the first standby position. In this state, since the opening and closing blade 20 moves in the gravity direction at the time of the shutter operation, it is conceivable that the curtain speed of the opening and closing blade 20 increases.

To correct this, it is conceivable to increase the execution speed of the electronic front curtain in accordance with the curtain speed of the opening and closing blade 20.

As a result, the curtain speed of the opening and closing blade 20 and the speed of the electronic front curtain are substantially the same speed, and the exposure time of each pixel can be made uniform.

Note that, instead of increasing the speed of the electronic front curtain, the curtain speed of the opening and closing blade 20 may be reduced by reducing the current caused to flow to the drive part 21, and the exposure time of each pixel may be made uniform.

FIG. 21 illustrates a case where the initial position of the opening and closing blade 20 is the second standby position. In this state, since the opening and closing blade 20 moves in a direction against gravity at the time of the shutter operation, it is conceivable that the curtain speed of the opening and closing blade 20 reduces.

To correct this, it is conceivable to reduce the execution speed of the electronic front curtain in accordance with the curtain speed of the opening and closing blade 20.

As a result, the curtain speed of the opening and closing blade 20 and the speed of the electronic front curtain are substantially the same speed, and the exposure time of each pixel can be made uniform.

Note that, instead of reducing the speed of the electronic front curtain, the curtain speed of the opening and closing blade 20 may be increased by increasing the current caused to flow to the drive part 21, and the exposure time of each pixel may be made uniform.

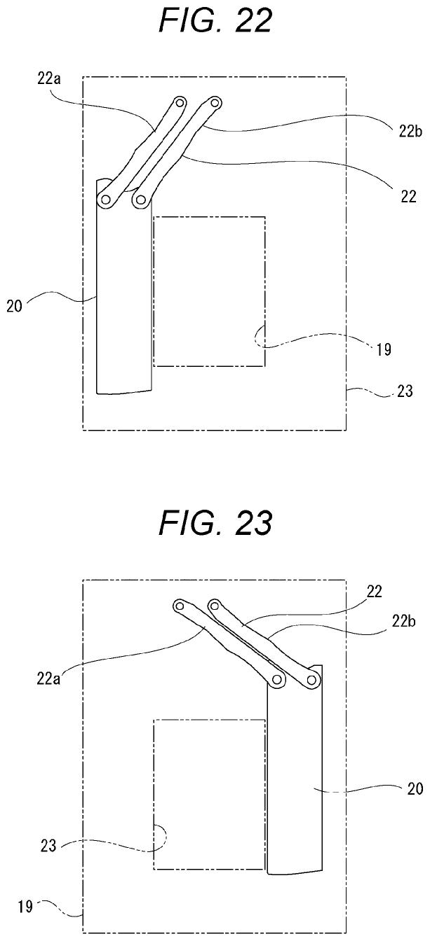

Next, correction in a case where the imaging device 1 is used in a state of being laid down on its side will be described with reference to FIGS. 22, 23, 24, and 25.

First, a case will be described where the support part 22 that supports the opening and closing blade 20 is located above the opening and closing blade 20 when the imaging device 1 is laid down on its side.

FIG. 22 illustrates a state in which the support part 22 is located above the opening and closing blade 20, and the opening and closing blade 20 is located at the first standby position.

In this state, since the moving direction of the opening and closing blade 20 at the time of traveling start is an obliquely downward direction, it is assumed that the opening and closing blade 20 moves fast due to influence of gravity.

To correct this, it is conceivable to increase the execution speed of the electronic front curtain in accordance with the curtain speed of the opening and closing blade 20.

As a result, the curtain speed of the opening and closing blade 20 and the speed of the electronic front curtain are substantially the same speed, and the exposure time of each pixel can be made uniform.

Note that, instead of increasing the speed of the electronic front curtain, the curtain speed of the opening and closing blade 20 may be reduced by reducing the current caused to flow to the drive part 21, and the exposure time of each pixel may be made uniform.

FIG. 23 illustrates a state in which the support part 22 is located above the opening and closing blade 20, and the opening and closing blade 20 is located at the second standby position.

In this state, since the moving direction of the opening and closing blade 20 at the time of traveling start is an obliquely downward direction, it is assumed that the opening and closing blade 20 moves fast due to influence of gravity.

To correct this, it is conceivable to increase the execution speed of the electronic front curtain in accordance with the curtain speed of the opening and closing blade 20.

As a result, the curtain speed of the opening and closing blade 20 and the speed of the electronic front curtain are substantially the same speed, and the exposure time of each pixel can be made uniform.

Note that, instead of increasing the speed of the electronic front curtain, the curtain speed of the opening and closing blade 20 may be reduced by reducing the current caused to flow to the drive part 21, and the exposure time of each pixel may be made uniform.

Next, a case will be described where the support part 22 that supports the opening and closing blade 20 is located below the opening and closing blade 20 when the imaging device 1 is laid down on its side.

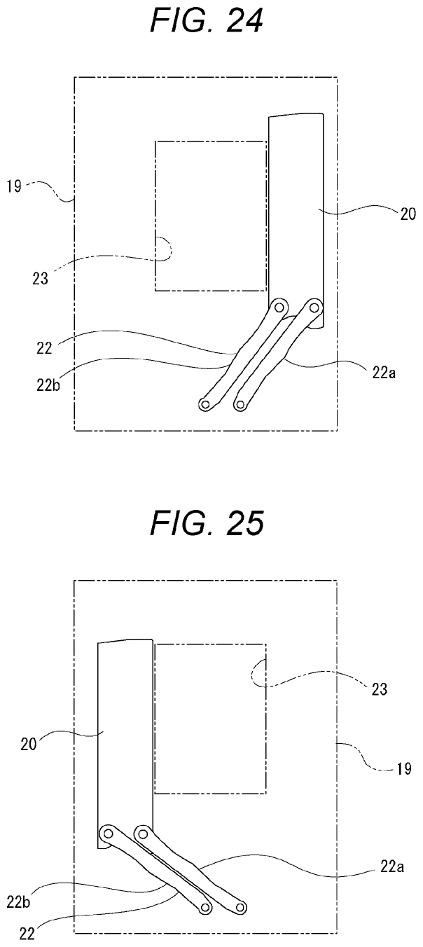

FIG. 24 illustrates a state in which the support part 22 is located below the opening and closing blade 20, and the opening and closing blade 20 is located at the first standby position.

In this state, since the moving direction of the opening and closing blade 20 at the time of traveling start is an obliquely upward direction, it is assumed that the opening and closing blade 20 moves slow due to influence of gravity.

To correct this, it is conceivable to reduce the execution speed of the electronic front curtain in accordance with the curtain speed of the opening and closing blade 20.

As a result, the curtain speed of the opening and closing blade 20 and the speed of the electronic front curtain are substantially the same speed, and the exposure time of each pixel can be made uniform.

Note that, instead of reducing the speed of the electronic front curtain, the curtain speed of the opening and closing blade 20 may be increased by increasing the current caused to flow to the drive part 21, and the exposure time of each pixel may be made uniform.

FIG. 25 illustrates a state in which the support part 22 is located below the opening and closing blade 20, and the opening and closing blade 20 is located at the second standby position.

In this state, since the moving direction of the opening and closing blade 20 at the time of traveling start is an obliquely upward direction, it is assumed that the opening and closing blade 20 moves slow due to influence of gravity.

To correct this, it is conceivable to reduce the execution speed of the electronic front curtain in accordance with the curtain speed of the opening and closing blade 20.

As a result, the curtain speed of the opening and closing blade 20 and the speed of the electronic front curtain are substantially the same speed, and the exposure time of each pixel can be made uniform.

Note that, instead of reducing the speed of the electronic front curtain, the curtain speed of the opening and closing blade 20 may be increased by increasing the current caused to flow to the drive part 21, and the exposure time of each pixel may be made uniform.

### 7. TRAVEL TIMING OF ELECTRONIC SHUTTER AND MECHANICAL SHUTTER

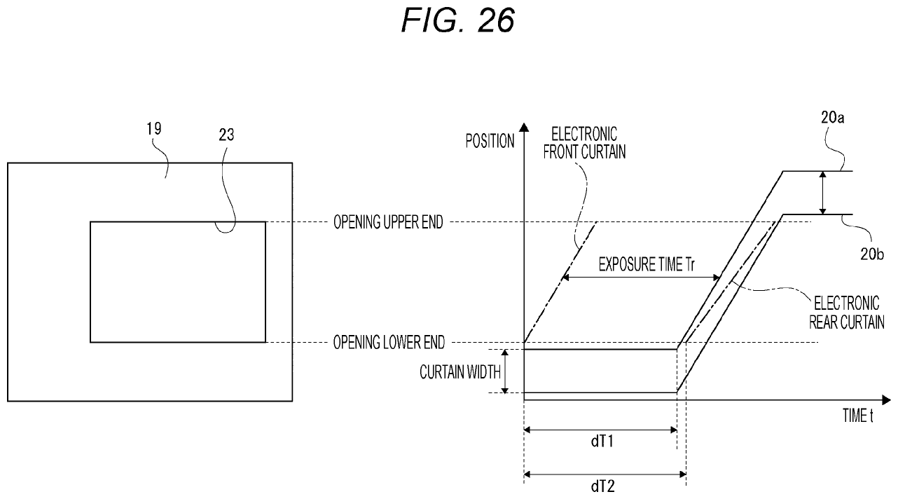

FIG. 26 is a graph schematically illustrating a position of the opening and closing blade 20 (mechanical shutter) with respect to the opening 23 of the base part 19 and a travel timing of an electronic shutter functioning as the electronic front curtain and the electronic rear curtain. Note that, FIG. 26 illustrates an example in which the opening and closing blade 20 located at the first standby position is driven in the first traveling mode.

As illustrated in the figure, the charge reset processing as the electronic front curtain is faster than the charge reading processing as the electronic rear curtain. For that reason, a problem that the exposure time differs for each pixel in a case where only the electronic front curtain and the electronic rear curtain are used is solved by using the opening and closing blade 20.

That is, even if each pixel of the imaging element 17 is at any position in the opening 23, a time length from passage of the electronic front curtain to passage of the front end portion 20a of the opening and closing blade 20 is constant. A traveling speed of the opening and closing blade 20 is determined depending on a processing speed of the electronic front curtain. The time length from the passage of the electronic front curtain to the passage of the front end portion 20a of the opening and closing blade 20, which is made constant, is an exposure time Tr.

Note that, as described above, the traveling start timing of the opening and closing blade 20 is a timing at which the time difference dT1 has elapsed from the traveling start timing of the electronic front curtain. However, the time difference dT1, which is a difference between the travel timings, and the exposure time Tr do not always have the same numerical value. Specifically, it is assumed that a relationship of Tr dT1 is satisfied.

The exposure time Tr is larger than the time difference dT1 in a case where a position of the front end portion 20a of the opening and closing blade 20 at the first standby position is different from a position of the lower end of the opening 23. This is because the light shielding is delayed by the time required for the front end portion 20a to reach the lower end portion of the opening 23 from the first standby position. In view of this, the time difference dT1 is determined.

The electronic rear curtain starts traveling at a timing when the time difference dT2 has elapsed from the traveling start timing of the electronic front curtain. Processing of the electronic rear curtain is started after the traveling of the opening and closing blade 20 is started.

The electronic rear curtain is configured to always travel at a position shielded from light by the opening and closing blade 20.

Note that, the electronic rear curtain may be started after a predetermined time has elapsed from the timing at which the traveling of the opening and closing blade 20 is started.

Note that, in the example illustrated in FIG. 26, the traveling of the opening and closing blade 20 is started after a predetermined time has elapsed from the end of the traveling of the electronic front curtain. However, in a case where the exposure time is short, control may be performed to implement so-called slit exposure in which the traveling of the opening and closing blade 20 is started before the electronic front curtain finishes traveling.

In a case where the imaging device 1 has the continuous shooting mode, a continuous shooting speed can be improved by applying the bidirectional mode in which the first traveling mode and the second traveling mode are alternately executed. That is, the first imaging operation (shutter operation) is executed when the opening and closing blade 20 moves from the first standby position to the second standby position in the first traveling mode, and the second imaging operation (shutter operation) is executed when the opening and closing blade is subsequently moved from the second standby position to the first standby position.

### 8. MODIFICATIONS

In a first modification, the traveling speed of the opening and closing blade 20 as the mechanical shutter is changed in the middle of traveling.

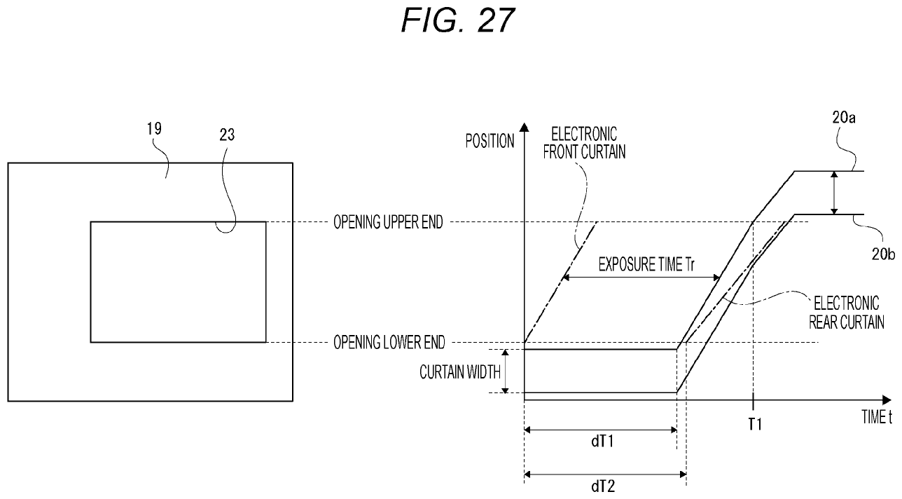

Description will be given specifically with reference to FIG. 27.

Similarly to FIG. 26, FIG. 27 is a graph schematically illustrating the position of the opening and closing blade 20 with respect to the opening 23 and the travel timing of the electronic shutter.

As illustrated in the figure, the speed of the opening and closing blade 20 is reduced at a timing (time T1) when the front end portion 20a is located above the opening 23. Specifically, the traveling speed of the opening and closing blade 20 reduces from a first speed to a second speed.

The timing (time T1) at which the front end portion 20a is located above the opening 23 is also a timing at which the exposure time of each pixel of the imaging element 17 is determined. That is, at the time T1, a pixel located in the region through which the opening and closing blade 20 has passed is a pixel for which the charge reading has already been completed, and a pixel being shielded from light by the opening and closing blade 20 is a pixel in a state in which further exposure is not performed.

In a time after the time T1, it is not necessary to match the traveling speed of the electronic front curtain with the traveling speed of the opening and closing blade 20, so that the traveling of the electronic rear curtain can be prevented from being excessively delayed with respect to the traveling speed of the opening and closing blade 20. That is, the traveling speed of the opening and closing blade 20 can be reduced in accordance with the traveling speed of the electronic rear curtain.

As a result, since the traveling speed of the electronic rear curtain can be reduced as compared with the example illustrated in FIG. 26, restriction of the processing speed can be relaxed, and choices of circuit components can be expanded. That is, a component cost can be reduced.

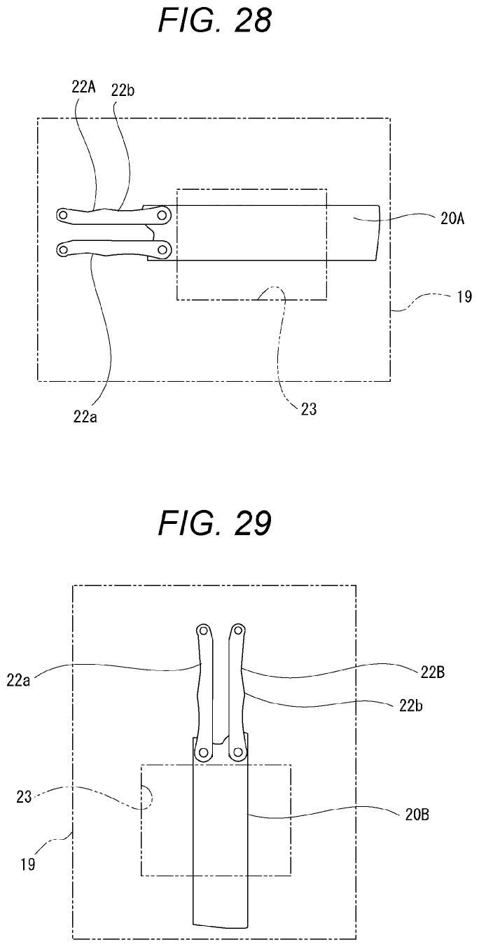

A second modification is different from the above-described configuration in configurations of the opening and closing blade 20 and the support part 22. FIG. 28 illustrates the base part 19, an opening and closing blade 20A, and a support part 22A according to the second modification.

The entire support part 22A is located outside the opening 23 in any rotation state. That is, arrangement is made so that the support part 22A does not cover the opening 23.

Accordingly, portions of the opening and closing blade 20A to which the links 22a and 22b of the support part 22A are respectively connected are also provided to be always located outside the opening 23.

As a result, since only the opening and closing blade 20A is a member that closes the opening 23, it is not necessary to perform design in consideration of a positional relationship between the support part 22A and the opening and closing blade 20A, so that the design can be simplified. That is, a design cost can be reduced.

In a third modification, a traveling direction of the opening and closing blade 20 with respect to the opening 23 is different. FIG. 29 illustrates the base part 19, an opening and closing blade 20B, and a support part 22B according to the third modification.

In the third modification, the traveling direction of the opening and closing blade 20B is the longitudinal direction of the opening 23. That is, the longitudinal direction of the opening and closing blade 20B coincides with the short side direction of the opening 23.

Since the length in the longitudinal direction of the opening and closing blade 20B may be determined in accordance with the length in the short side direction of the opening 23, the length in the longitudinal direction of the opening and closing blade 20B can be made shorter than that in each of the above-described examples. Thus, since an area of the opening and closing blade 20B can be reduced, downsizing of the opening and closing blade 20B can be achieved. As a result, the component cost can be reduced.

Note that, due to the downsizing of the opening and closing blade 20B, it is possible to reduce the moment of inertia during operation of the opening and closing blade 20B, so that fault tolerance of each part can be improved.

Note that, in the opening and closing blades 20 and 20A described up to the second modification, the longitudinal direction of the opening 23 and the longitudinal direction of the opening and closing blades 20 and 20A coincide with each other. As a result, since the short side direction of the opening 23 is the traveling direction of the opening and closing blades 20 and 20A, a traveling distance of the opening and closing blades 20 and 20A at the time of the shutter operation can be shortened. As a result, a high-speed shutter operation can be performed, and thus rolling shutter distortion and the like can be suppressed.

A fourth modification is an example in which the traveling of the opening and closing blade 20 is caused to be started at a timing before the traveling start of the electronic front curtain.

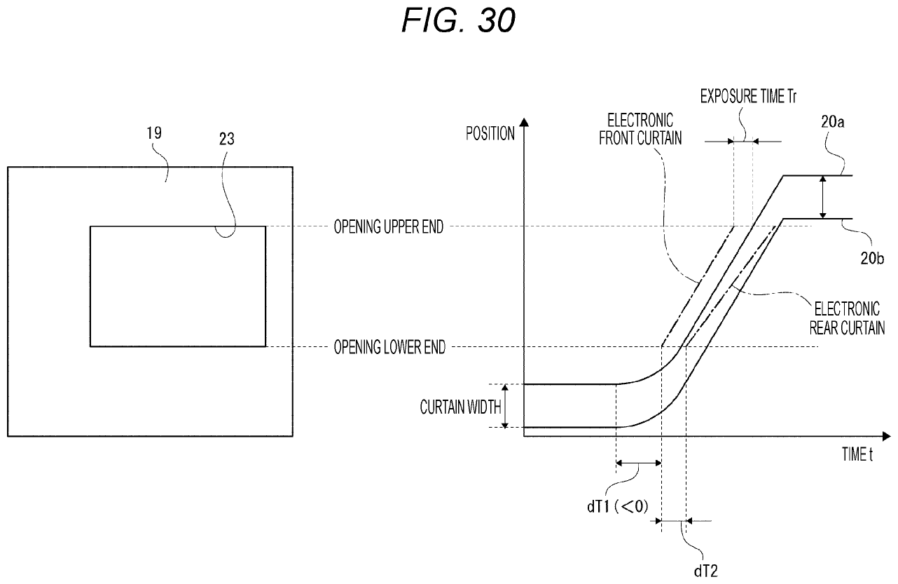

Description will be given specifically with reference to FIG. 30.

The traveling start timing of the opening and closing blade 20 is determined depending on the exposure time of each pixel of the imaging element 17. For example, as the exposure time is shorter, the traveling start timing of the opening and closing blade 20 arrives without a period from the traveling start timing of the opening and closing blade 20.

Here, behavior of the opening and closing blade 20 at the traveling start is considered.

The opening and closing blade 20 performs accelerated motion until reaching a certain speed.

Thus, in a case where the exposure time is shorter than a time length from the traveling start of the opening and closing blade 20 to reaching the certain speed, it is necessary to start traveling of the opening and closing blade 20 before the traveling start of the electronic front curtain.

Furthermore, also in a case where a distance is long between the front end portion 20a and one end (for example, the lower end) of the opening at a standby position (for example, the first standby position) of the opening and closing blade 20, it is necessary to start traveling of the opening and closing blade 20 before the traveling start of the electronic front curtain.

In a case where the traveling of the opening and closing blade 20 is started before the traveling start of the electronic front curtain, the time difference dT1 from the traveling start of the electronic front curtain to the traveling start of the opening and closing blade 20 has a negative value. That is, as illustrated in FIG. 30, first, the traveling of the opening and closing blade 20 is started, and then the traveling of the electronic front curtain is started.

The traveling of the opening and closing blade 20 is started before that of the electronic front curtain, but each pixel of the imaging element 17 is shielded from light by the opening and closing blade 20 after the traveling of the electronic front curtain.

Furthermore, the speed of the opening and closing blade 20 reaches the certain speed before the front end portion 20a of the opening and closing blade 20 reaches one end of the opening 23.

Note that, in the other examples described above, the time difference dT1 is smaller than the exposure time Tr (Tr dT1). However, as the exposure time is shorter and the time for performing the accelerated motion of the opening and closing blade 20 is longer, the time difference dT1 is smaller and has a negative value at a certain point of time. Moreover, when the exposure time is short and the time for performing the accelerated motion of the opening and closing blade 20 is long, the absolute value of the time difference dT1 is larger than the exposure time Tr (Tr<absolute value of dT1) as illustrated in FIG. 30.

According to the configuration of the present application, regardless of the relationship between the exposure time Tr and the time difference dT1 (or the absolute value of the time difference dT1), the number of components for performing appropriate exposure control can be reduced, and effects of weight reduction and speed improvement of the opening and closing blade 20 can be obtained.

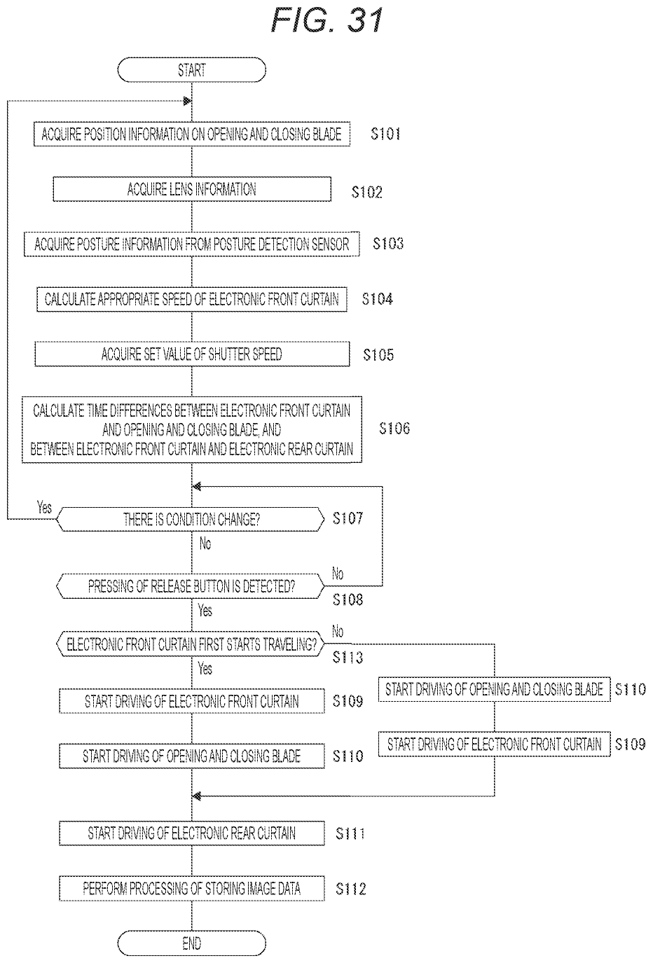

FIG. 31 illustrates a flowchart of shutter operation in the fourth modification.

Note that, processing similar to that in FIG. 17 is denoted by the same reference numeral, and description thereof is omitted as appropriate.

After detecting the pressing of the release button in step S108, the imaging device 1 determines whether or not the electronic front curtain first starts traveling in step S113. For example, by acquiring an exposure time determined by various settings and determining whether or not the exposure time is less than a predetermined time, which of the electronic front curtain and the opening and closing blade 20 is to be driven first is determined.

In a case where it is determined to drive the electronic front curtain first, the imaging device 1 executes the processing in the order of steps S109 and S110.

On the other hand, in a case where it is determined to drive the opening and closing blade 20 first, the imaging device 1 executes the processing in the order of steps S110 and S109.

By executing a series of processing steps illustrated in FIG. 31, it is possible to secure an appropriate exposure time of the imaging element 17 in consideration of the accelerated motion immediately after the start of driving of the opening and closing blade 20.

### 9. CONCLUSION

As illustrated in each of the examples described above, the imaging device 1 (1A, 1B) includes: the imaging element 17 that receives light from a subject and performs photoelectric conversion; the control unit 10 that controls the timing of the charge reset (travel timing of the electronic front curtain) of the imaging element 17; the base part 19 that is disposed on the front surface of the imaging element 17 and includes the opening 23 through which light transmits; and the shutter unit 16 that includes only one opening and closing blade 20 (20A, 20B) that shields a part of the opening 23 from light depending on the timing of the charge reset and includes the support part 22 that supports the opening and closing blade 20 (20A, 20B), in which the width of the opening and closing blade 20 in the traveling direction is smaller than the width of the opening 23 in the traveling direction.

Since the shutter unit 16 includes only one opening and closing blade 20, the weight of the opening and closing blade 20 can be reduced.

Furthermore, since the opening and closing blade 20 has a smaller width in the traveling direction than the opening 23, it is possible to significantly reduce the weight of the opening and closing blade 20. As a result, the operation speed of the opening and closing blade 20 can be increased, and a quick imaging operation (shutter operation) can be implemented. Furthermore, the weight of the opening and closing blade 20 is reduced, whereby it is possible to improve the failure resistance of the opening and closing blade 20.

Moreover, the number of components can be reduced as compared with a case where a plurality of the opening and closing blades 20 is provided, and a mechanism is unnecessary for moving the plurality of opening and closing blades 20 in conjunction with each other, so that it is possible to contribute to simplification of the structure, reduction in the number of components, and cost reduction. Furthermore, design complexity can be avoided.

As described in the flowchart of the shutter operation, the control unit 10 may perform the charge reset (electronic front curtain) prior to the traveling of the opening and closing blade 20.

For example, after the charge reset is performed for each pixel of the imaging element 17, the opening and closing blade 20 travels after an elapsed time according to the shutter speed.

As a result, each pixel is exposed from the charge reset to the traveling of the opening and closing blade 20, and captured image data by photoelectric conversion can be obtained.

As described in the travel timings of the electronic shutter and the mechanical shutter, the opening and closing blade 20 may include the front end portion 20a that is the end portion on the traveling direction side and the rear end portion 20b that is the end portion on the opposite side, and the moving speed of the opening and closing blade 20 may be determined depending on the reset speed of the electronic front curtain by the charge reset.

For example, in a case where the opening and closing blade 20 travels from the bottom to the top, the upper end portion is the front end portion 20a, and the lower end portion is the rear end portion 20b. Furthermore, in a case where the opening and closing blade 20 travels from the top to the bottom, the lower end portion is the front end portion 20a, and the upper end portion is the rear end portion 20b.

Furthermore, for example, the moving speed of the opening and closing blade 20 is equivalent to the charge reset speed of the electronic front curtain. That is, the time required for the front end portion 20a of the opening and closing blade 20 to move from one end to the other end of the opening 23 is equivalent to the time required for the charge reset of each pixel located in the opening 23.

As a result, it is possible to make the time uniform that is required from the charge reset to being shielded from light by the opening and closing blade 20 in each pixel.

Furthermore, by matching the moving speed (traveling speed) of the opening and closing blade 20 with the charge reset speed set at a relatively high speed, it is possible to reduce the rolling shutter distortion.

As described in the travel timings of the electronic shutter and the mechanical shutter, the control unit 10 may perform the charge reading (electronic rear curtain) of the imaging element 17 depending on the traveling of the opening and closing blade 20.

For example, the charge reading of each pixel located in the opening 23 is performed to follow the traveling of the opening and closing blade 20.

As a result, the exposure time of each pixel located in the opening 23 can be made uniform, and appropriate captured image data can be obtained.

As described in the flowchart of the shutter operation and the like, the control unit 10 may cause the charge reading (electronic rear curtain) to be started after the traveling start of the opening and closing blade 20.

For example, the charge reading of each pixel is caused to be started immediately after the traveling start of the opening and closing blade 20.

As a result, captured image data can be obtained on the basis of the exposure time from the charge reset to being shielded from light by the opening and closing blade.

As described in the travel timings of the electronic shutter and the mechanical shutter, the control unit 10 may perform the charge reading (electronic rear curtain) on the pixel being shielded from light by the opening and closing blade 20.

As a result, a pixel before being shielded from light by the opening and closing blade 20 is set as a pixel being exposed, and a pixel through which the opening and closing blade 20 has passed is set as a pixel for which the charge reading is completed.

That is, the exposure time of each pixel can be made constant. Furthermore, for the pixel through which the opening and closing blade 20 has passed, since the charge reading is completed, there is no need to shield the pixel from light. Thus, it is possible to appropriately perform control from the start to the completion of the exposure by one opening and closing blade 20.

As described in the travel timings of the electronic shutter and the mechanical shutter and the like, the opening and closing blade 20 may have the first traveling mode in which he opening and closing blade 20 travels from one end side of the opening 23 toward the other end side that is paired with the one end side, and the second traveling mode in which the opening and closing blade 20 travels from the other end side toward the one end side, and the control unit 10 may have the bidirectional mode in which the charge reading is performed in both the first traveling mode and the second traveling mode.

That is, the shutter operation is performed in both the forward path in which the opening and closing blade 20 moves in one direction on the opening 23 and the backward path in which the opening and closing blade moves in the opposite direction.

Thus, as compared with a case where the opening and closing blade 20 needs to reciprocate every time one shutter operation is performed, two shutter operations in total, one shutter operation in each of the forward path and the backward path, are performed. As a result, a moving distance of the opening and closing blade 20 necessary for one shutter operation is shortened, so that the power consumption can be reduced, and the consumption of the battery can be suppressed. Furthermore, in particular, only one opening and closing blade 20 is provided, whereby electric power required for executing one shutter operation by moving the lightweight opening and closing blade 20 is significantly reduced.

Moreover, since reciprocating operation of the opening and closing blade 20 is unnecessary for one shutter operation, a high-speed shutter operation can be implemented.

As described in the travel timings of the electronic shutter and the mechanical shutter and the like, the control unit 10 may cause the bidirectional mode to be executed in the continuous shooting mode in which still images are continuously acquired.

The continuous shooting mode is, for example, an imaging mode executed in a case where the release button is continuously pressed for a certain period of time or more.

The configuration that enables shutter operation in each of the forward path and the backward path of the opening and closing blade 20 can implement high-speed shutter operation, and thus has high affinity in the continuous shooting mode. Furthermore, it is possible to implement high-speed continuous imaging as compared with a case where one shutter operation is performed by the reciprocating operation of the opening and closing blade 20.

As described in the operation of the shutter unit and the like, the support part 22 during the traveling of the opening and closing blade 20 may be made not to overlap the non-light-shielded region that is the portion of the opening 23 that is not shielded from light by the opening and closing blade 20.

The non-light-shielded region that is not shielded from light by the opening and closing blade 20 may be one located on the front end portion 20a side that is the end portion on the traveling direction side of the opening and closing blade 20, or may be one located on the rear end portion 20b side on the opposite side thereof. Those non-light-shielded regions each are, for example, a region divided only by the edge portion of the opening 23 and the opening and closing blade 20 with a rectangular shape, and has a substantially rectangular shape.

That is, since the non-light-shielded region has a substantially rectangular shape by disposing the support part 22 not to overlap the non-light-shielded region, it is easy to make the exposure time for each pixel constant for each shutter operation in the forward path and the backward path of the opening and closing blade 20. As a result, it is possible to obtain appropriate captured image data.

As described in the operation of the shutter unit and the like, the support part 22 may be configured such that the entire portion overlapping the opening 23 overlaps the opening and closing blade 20 during the traveling of the opening and closing blade 20.

That is, the entire portion of the support part 22 located on the opening 23 is disposed to overlap the opening and closing blade 20, whereby the non-light-shielded region is a region divided only by the edge portion of the opening 23 and the opening and closing blade 20.

As a result, it can be easily implemented that the non-light-shielded region is formed in a substantially rectangular shape. That is, the exposure time for each pixel can be easily made uniform.

As described in the second modification, during the traveling of the opening and closing blade 20A, the entire portion of the support part may be located outside the opening 23.

The support part 22A is located outside the opening 23, whereby the non-light-shielded region is a region divided only by the edge portion of the opening 23 and the opening and closing blade 20A.

As a result, it can be easily implemented that the non-light-shielded region is formed in a substantially rectangular shape, and it becomes easy to make the exposure time for each pixel uniform in each of the forward path and the backward path of the opening and closing blade 20A.

As described in the configuration of the shutter unit and the like, the shutter unit 16 includes the drive part 21 that drives the support part 22, and the control unit 10 is enabled to change the output of the drive part 21 depending on the first traveling mode and the second traveling mode.

For example, the first traveling mode is a mode in which the opening and closing blade 20 is moved from the lower side to the upper side of the opening 23. Furthermore, the second traveling mode is a mode in which the opening and closing blade 20 is moved from the upper side to the lower side of the opening 23.

In such a case, there is a possibility that the traveling speeds of the opening and closing blade 20 on the forward path and the backward path differs from each other due to the influence of gravity. By changing the output of the drive part 21 depending on the traveling mode, the traveling speeds of the opening and closing blades 20 in the forward path and backward path can be made uniform.

As described in the correction based on the posture information and the initial position, the shutter unit 16 may include the drive part 21 that drives the support part 22, and the control unit 10 may be enabled to change the output of the drive part 21 depending on the posture of the shutter unit 16.

There is a possibility that in the imaging device 1, imaging is performed in various postures depending on imaging situations.

In such a case, it is possible to make the traveling speeds of the opening and closing blade 20 of the forward path and the backward path uniform by detecting whether or not the traveling speed is lowered due to the posture of the shutter unit 16 and changing the output of the drive part 21 depending on the posture.

As described in the first modification (FIG. 27), the opening and closing blade 20 may include the front end portion 20a that is the end portion on the traveling direction side and the rear end portion 20b that is the end portion on the opposite side, and the control unit 10 may cause the opening and closing blade 20 to travel at the first speed when the front end portion 20a changes from a state of being located outside the opening 23 to a state of being located in the opening 23, cause the opening and closing blade 20 to travel at the second speed in a state in which the front end portion 20a is located outside the opening 23 and the rear end portion 20b is located in the opening 23, and cause the second speed to be slower than the first speed.

That is, the opening and closing blade 20 travels at the first speed (for example, the initial speed) while the front end portion 20a is located in the opening 23, and the opening and closing blade 20 travels at the second speed while the front end portion 20a reaches the end portion of the opening 23 and is located outside the opening 23.

The charge reading of each pixel has to be performed while being shielded from light by the opening and closing blade 20. Furthermore, there is a case where the charge reading speed is slower than the charge reset speed. In such a case, since the movement of the opening and closing blade 20 is delayed at a late stage of the shutter operation, a light shielding time of the pixel that is shielded from light last by the opening and closing blade 20 is long, and thus, it is possible to perform the charge reading in time. That is, even if the time required for the charge reading is delayed to some extent with respect to the time required for the charge reset, it is possible to allow the delay.

Note that, the advantageous effects described in the specification are merely examples, and the advantageous effects of the present technology are not limited to them and may include other effects.

### 10. PRESENT TECHNOLOGY

The present technology can also adopt the following configurations.

(1)

An imaging device including:

an imaging element that receives light from a subject and performs photoelectric conversion;

a control unit that controls a timing of a charge reset of the imaging element; and

a shutter unit including a base part that is disposed on a front surface of the imaging element and includes an opening through which light passes, an opening and closing blade that shields a part of the opening from light depending on the timing of the charge reset, and a support part that supports the opening and closing blade, in which

only one opening and closing blade is included, and a width of the opening and closing blade in a traveling direction is smaller than a width of the opening in the traveling direction.

(2)

The imaging device according to (1), in which

the control unit performs the charge reset prior to traveling of the opening and closing blade.

(3)

The imaging device according to any of (1) to (2), in which

a moving speed of the opening and closing blade is determined depending on a reset speed of an electronic front curtain by the charge reset.

(4)

The imaging device according to any of (1) to (3), in which

the control unit causes charge reading of the imaging element to be started depending on traveling of the opening and closing blade.

(5)

The imaging device according to (4), in which

the control unit causes the charge reading to be started after a traveling start of the opening and closing blade.

(6)

The imaging device according to (5), in which

the control unit performs control to cause the charge reading to be performed on a pixel being shielded from light by the opening and closing blade.

(7)

The imaging device according to any of (4) to (6), in which

the opening and closing blade has a first traveling mode in which the opening and closing blade travels from one end side of the opening toward another end side on an opposite side and a second traveling mode in which the opening and closing blade travels from the another end side toward the one end side, and

the control unit has a bidirectional mode in which the charge reset and the charge reading are performed in both the first traveling mode and the second traveling mode.

(8)

The imaging device according to (7), in which

the control unit causes the bidirectional mode to be executed in a continuous shooting mode in which still images are continuously acquired.

(9)

The imaging device according to any of (7) to (8), in which

the support part during traveling of the opening and closing blade does not overlap a non-light-shielded region that is a portion of the opening that is not shielded from light by the opening and closing blade.

(10)

The imaging device according to (9), in which

during the traveling of the opening and closing blade, the support part overlaps the opening and closing blade at an entire portion overlapping the opening.

(11)

The imaging device according to (9), in which

during the traveling of the opening and closing blade, an entire portion of the support part is located outside the opening.

(12)

The imaging device according to any of (7) to (11), in which

the shutter unit includes a drive part that drives the support part, and

the control unit changes an output of the drive part between the first traveling mode and the second traveling mode.

(13)

The imaging device according to any of (1) to (12), in which

the shutter unit includes a drive part that drives the support part, and

the control unit changes an output of the drive part depending on a posture of the shutter unit.

(14)

The imaging device according to any of (1) to (13), in which

the opening and closing blade includes a front end portion that is an end portion on a traveling direction side and a rear end portion that is an end portion on an opposite side, and

the control unit causes the opening and closing blade to travel at a first speed when a state of the front end portion changes from a state of being located outside the opening to a state of being located in the opening, and causes the opening and closing blade to travel at a second speed lower than the first speed in a state in which the front end portion is located outside the opening and the rear end portion is located in the opening.

(15)

A shutter unit including:

a base part disposed on a front surface of an imaging element and including an opening through which light is transmitted;

an opening and closing blade that shields a part of the opening from light depending on a timing of a charge reset; and

the shutter unit including a support part that supports the opening and closing blade, in which

only one opening and closing blade is included, and a width of the opening and closing blade in a traveling direction is smaller than a width of the opening in the traveling direction.

(16)

A shutter control method in an imaging device including:

an imaging element that receives light from a subject, performs photoelectric conversion, and resets electric charge of each of pixels depending on a timing of a charge reset; and

a shutter unit including a base part that is disposed on a front surface of the imaging element and includes an opening through which light transmits, an opening and closing blade that shields a part of the opening from light depending on the timing of the charge reset, and a support part that supports the opening and closing blade, in which

only one opening and closing blade is included, and a width of the opening and closing blade in a traveling direction is smaller than a width of the opening in the traveling direction,

the shutter control method including:

performing the charge reset of the imaging element;

causing traveling of the opening and closing blade to be started; and

performing charge reading of a pixel located in a region shielded from light by the opening and closing blade.

### REFERENCE SIGNS LIST

1 Imaging device
10 Control unit
16 Shutter unit
17 Imaging element
19 Base part
20 Opening and closing blade
20A Opening and closing blade
20B Opening and closing blade
20a Front end portion
20b Rear end portion
21 Drive part
22 Support part
22A Support part
22B Support part
23 Opening

1. An imaging device comprising:
an imaging element that receives light from a subject and performs photoelectric conversion;
a control unit that controls a timing of a charge reset of the imaging element; and
a shutter unit including a base part that is disposed on a front surface of the imaging element and includes an opening through which light passes, an opening and closing blade that shields a part of the opening from light depending on the timing of the charge reset, and a support part that supports the opening and closing blade, wherein
only one opening and closing blade is included, and a width of the opening and closing blade in a traveling direction is smaller than a width of the opening in the traveling direction.

2. The imaging device according to claim 1, wherein
the control unit performs the charge reset prior to traveling of the opening and closing blade.

3. The imaging device according to claim 1, wherein
a moving speed of the opening and closing blade is determined depending on a reset speed of an electronic front curtain by the charge reset.

4. The imaging device according to claim 1, wherein
the control unit causes charge reading of the imaging element to be started depending on traveling of the opening and closing blade.

5. The imaging device according to claim 4, wherein
the control unit causes the charge reading to be started after a traveling start of the opening and closing blade.

6. The imaging device according to claim 5, wherein
the control unit performs control to cause the charge reading to be performed on a pixel being shielded from light by the opening and closing blade.

7. The imaging device according to claim 4, wherein
the opening and closing blade has a first traveling mode in which the opening and closing blade travels from one end side of the opening toward another end side on an opposite side and a second traveling mode in which the opening and closing blade travels from the another end side toward the one end side, and
the control unit has a bidirectional mode in which the charge reset and the charge reading are performed in both the first traveling mode and the second traveling mode.

8. The imaging device according to claim 7, wherein
the control unit causes the bidirectional mode to be executed in a continuous shooting mode in which still images are continuously acquired.

9. The imaging device according to claim 7, wherein
the support part during traveling of the opening and closing blade does not overlap a non-light-shielded region that is a portion of the opening that is not shielded from light by the opening and closing blade.

10. The imaging device according to claim 9, wherein
during the traveling of the opening and closing blade, the support part overlaps the opening and closing blade at an entire portion overlapping the opening.

11. The imaging device according to claim 9, wherein
during the traveling of the opening and closing blade, an entire portion of the support part is located outside the opening.

12. The imaging device according to claim 7, wherein
the shutter unit includes a drive part that drives the support part, and
the control unit changes an output of the drive part between the first traveling mode and the second traveling mode.

13. The imaging device according to claim 1, wherein
the shutter unit includes a drive part that drives the support part, and
the control unit changes an output of the drive part depending on a posture of the shutter unit.

14. The imaging device according to claim 1, wherein
the opening and closing blade includes a front end portion that is an end portion on a traveling direction side and a rear end portion that is an end portion on an opposite side, and
the control unit causes the opening and closing blade to travel at a first speed when a state of the front end portion changes from a state of being located outside the opening to a state of being located in the opening, and causes the opening and closing blade to travel at a second speed lower than the first speed in a state in which the front end portion is located outside the opening and the rear end portion is located in the opening.

15. A shutter unit comprising:
a base part disposed on a front surface of an imaging element and including an opening through which light is transmitted;
an opening and closing blade that shields a part of the opening from light depending on a timing of a charge reset; and
the shutter unit including a support part that supports the opening and closing blade, wherein
only one opening and closing blade is included, and a width of the opening and closing blade in a traveling direction is smaller than a width of the opening in the traveling direction.

16. A shutter control method in an imaging device including:
an imaging element that receives light from a subject, performs photoelectric conversion, and resets electric charge of each of pixels depending on a timing of a charge reset; and
a shutter unit including a base part that is disposed on a front surface of the imaging element and includes an opening through which light transmits, an opening and closing blade that shields a part of the opening from light depending on the timing of the charge reset, and a support part that supports the opening and closing blade, wherein
only one opening and closing blade is included, and a width of the opening and closing blade in a traveling direction is smaller than a width of the opening in the traveling direction,
the shutter control method comprising:
performing the charge reset of the imaging element;
causing traveling of the opening and closing blade to be started; and
performing charge reading of a pixel located in a region shielded from light by the opening and closing blade.
